(19) United States
(12) Patent Application Publication
(10) Pub. No.: US 2002/0103815 A1
(43) Pub. Date: Aug. 1, 2002

(54) High speed data updates implemented in an information storage and retrieval system

(75) Inventors: Edouard Duvillier, Sunnyvale, CA (US); Didier Cabannes, Foster City, CA (US)

Correspondence Address: BEYER WEAVER & THOMAS LLP, P.O. BOX 778, BERKELEY, CA, 94704-0778, US

(73) Assignee: Fresher Information Corporation

(21) Appl. No.: 09/736,038

(22) Filed: Dec. 12, 2000

(51) Int. Cl. G06F 12/00

(52) U.S. Cl. 707/203

(57) ABSTRACT

A process for performing a transaction, such as a write operation, on a data object in a non-log based database is described. An information storage and retrieval system described can execute a transaction at a speed limited only by the hardware of the system. Updates to the data are done in sequential block writes which allow the data to be written continually to memory. This allows for real-time feed of large blocks of data, such as Web content of all types, into the database. The process described allows for handling large data updates in the same manner as small data updates. An entry for a data object containing version data for the data object is created and maintained in an object table. This entry for the data object is written or saved to a non-persistent memory, such as a cache memory at a particular non-persistent memory address. This write operation is then committed by saving the data object in a persistent memory area at a persistent memory area address. With respect to this write transaction, at least one inconsistent data page is identified in the non-persistent memory. This inconsistent data page is then written to the persistent memory area.

### BACKGROUND OF THE INVENTION

1. Field of the Invention

The present invention relates generally to information storage and retrieval systems, and more specifically to a technique for improving performance of information storage and retrieval systems.

2. Background

Over the past decade, advances in computer and network technologies have dramatically changed the degree and type of information to be saved by and retrieved from information storage and retrieval systems. As a result, conventional database systems are continually being improved to accommodate the changing needs of many of today's computer networks.

One common type of conventional information storage and retrieval system is the relational database management system (RDBMS), such as that shown, for example, in FIG. 1A of the drawings. The RDBMS system 100 of FIG. 1A utilizes a log-based system architecture for processing information storage and retrieval transactions. The log-based system architecture has become an industry standard, and is widely used in a variety of conventional RDBMS systems including, for example, IBM systems, Oracle systems, the well-known System R, etc.

Traditionally, the log-based system architecture was designed to handle many small or incremental update transactions for computer systems such as those associated with banks, or other financial institutions. According to conventional practice, when it is desired to record an update transaction using a conventional RDBMS system (such as that shown in FIG. 1A), the transaction information is first passed to a data server 104, which then accesses a buffer table 106 to determine the physical memory location of where the update transaction information should be stored. Typically the buffer table 106 provides a mapping for translating a given data object with an associated physical address location in the database 120. Each time information in the RDBMS system is to be accessed, the data server 104 must first access the buffer table 106 in order to determine the physical address of the memory location where the desired information is located. Once the physical address of the desired memory location has been determined, the updated data object may then written to the database 120 over the previous version of that data object. Additionally, a log record of the update transaction is created and stored in the log file 122. The log file is typically used to keep track of changes or updates which occur in the database 120.

As stated previously, the log-based system architecture was originally designed for maintaining records of multiple small, discreet transactions. For example, the log-based system architecture is ideally suited for handling financial transactions such as a customer deposit to a banking account. Using this example for purposes of illustration, it will be assumed that the customer has an existing account balance which is stored in database 120 as Data Item C 120C. Each data item in the database 120 may be stored at a physically distinct location in the storage device of the database 120. Typically, the storage device is a high-capacity disk drive.

It is further assumed in this example that the customer makes a deposit to his or her banking account. When the deposit information is entered into the computer system, an updated account balance for the customer's account is calculated. The updated account balance information, which includes the customer banking account number, is then forwarded to the data server 104. Assuming that the disk address or row ID corresponding to Data Item C is already known (such as, for example, by performing an index traversal or a table lookup), the data server 104 then consults the buffer table 106 to determine the location in the memory cache 124 where information relating to the identified customer account is located. Once the memory location information has been obtained from the buffer table, the data server 104 then updates the account balance information in the memory cache. The cached Data Item C will eventually be updated in place in database 120 at the physical memory location allocated to Data Object C. As a result, the updated account balance information is written over the previous account balance information of that customer account (which had been stored at the disk address allocated to Data Object C). Additionally, for purposes of recovery protection, the deposit transaction information (e.g. deposit amount, disk address) is appended to a log file 122A.

A more detailed description of conventional RDBMS systems is provided in the document entitled “Oracle 8i Concepts”, release 8.1.5, February 1999, published by Oracle Corporation of Redwood City, Calif. That document is incorporated herein by reference in its entirety for all purposes.

From the example above, it will be appreciated that log-based system architectures (such as that shown in FIG. 1A) are well suited for handling transactions involving small, fixed-size data items. However, the emergence of the Internet has dramatically changed the type and amount of information to be handled by conventional information storage and retrieval systems. For example, many of today's network applications generate transactions which require large or complex, variable-size data items to be written to and retrieved from information storage and retrieval systems. Additionally, content providers frequently perform content aggregation, which may involve the updating of content on a website or portal. For example, a transaction may involve the updating of large textual information and/or images, which may include hundreds or even thousands of kilobytes of information. Since log-based system architectures have been designed to handle transactions involving small, fixed-size data items, they are ill equipped to handle the large data transactions involved with many of today's network applications.

For example, log-based information storage and retrieval systems are not designed to handle large data updates produced, for example, by the updating of content of a website or web portal. Although it is desirable for content providers to be able to dynamically update entire portions of the content of their website in real-time, conventional information storage and retrieval systems are typically not designed to include an efficient mechanism for providing such capabilities. Accordingly, content providers are typically required to statically or manually update the content of their website in one or more separate files which are not real-time accessible to end users. After the desired content has been updated in an off-line file, the updated information is then transferred to a location which is then made accessible to end users. During the transfer or updating of the content information, that portion of the content provider's website is typically inaccessible to end users.

Another limitation of conventional RDBMS systems is that the log-based nature of the RDBMS system typically requires that any updates to a data item stored within the database 120 continually be written to the same physical space (e.g. disk space) where that object is stored. Thus, it will be appreciated that for each write to database 120, the disk head must be repositioned each time an item is to be updated in order to access the physical disk space where that object is stored. This introduces undesirable delays in accessing data within the RDBMS system. Moreover, until the writing of the log record for the updated transaction is completed, no other object update transactions may be written to the database 120. This introduces additional undesirable delays. Further delays may be also introduced during log truncation and recovery.

Thus it will be appreciated that the log-based architecture design of conventional RDBMS systems may result in a number of undesirable access and delay problems when handling large data transactions. For example, if updates are being performed on portions of data stored within a conventional RDBMS system, users will typically be unable to access any portion of the updated data until after the entirety of the data update has been completed. If the user attempts to access a portion of the data while the update is occurring, the user will typically experience a hanging problem, or will be handed dirty data (e.g. stale data) until the update transaction(s) have been completed. In light of this problem, content providers typically resort to setting up a second database which includes the updated information, while simultaneously enabling end users to access the first database (e.g. which includes the stale data) until the second database is ready to go on-line. However, it will be appreciated that such an approach demands a relatively large amount of resources for implementation, particularly with respect to memory resources.

Another limitation of conventional RDBMS systems is that, typically, they are not designed to support the indexing of the contents of text files or binary large object (BLOB) files, such as, for example, image files, video files, audio files, etc. FIG. 1B shows a schematic block diagram illustrating how a conventional RDBMS system handles the storage and retrieval of a BLOB 170. As shown in FIG. 1B, the RDBMS system includes a title index 150 which may be used to locate the specific table (e.g. 160) which stores the physical disk address information of a specified BLOB. When access to a specified BLOB (e.g. BLOB 170) is requested, the title index 150 is first consulted to determine the particular table (e.g. table 160) which contains the disk address information relating to the specified BLOB. As shown in FIG. 1B, an entry 160A corresponding to the specified BLOB 170 is located in table 160. The entry 160A includes a physical disk address 160B which corresponds to the address of the location where the BLOB 170 may be accessed. Typically, it is recommended that BLOBs not be stored within the RDBMS, but rather, that they should be stored in a file system external to the RDBMS. Thus, for example, in order to access the BLOB 170, the RDBMS must first access a buffer table 106 to convert the physical ID of the BLOB 170 into a logical ID, which may then be used to access the BLOB 170 in the external file system.

In light of the above, it will be appreciated that there is a continual need to improve upon information storage and retrieval techniques in order to accommodate new and emerging technologies and applications.

### SUMMARY OF THE INVENTION

A method and computer program product for performing a write transaction or other type of data modifying transaction of a data object to a database is described. An entry for a data object containing version data for the data object is created and maintained in an object table. This entry for the data object is written or saved to a non-persistent memory, such as a cache memory at a particular non-persistent memory address. This write operation is then committed by saving the data object in a persistent memory area at a persistent memory area address. With respect to this write transaction, at least one inconsistent data page is identified in the non-persistent memory. This inconsistent data page is then written to the persistent memory area.

In one embodiment the persistent memory address is associated with the entry for the data object stored in the object table in the non-persistent memory. In another embodiment the non-persistent memory address of the data object is determined and stored in the entry in the object table. In yet another embodiment the non-persistent memory address value in the entry is replaced with the value of the persistent memory address. In another embodiment the entry in the object table is created concurrently with the data object being written to the non-persistent memory. In yet another embodiment the object table is stored in the non-persistent and persistent memories. In yet another embodiment, it is determined whether the entry represents a single version of the data object or multiple versions of the data object. If the entry represents a single version, the entry is stored in the portion of the object table stored in persistent memory and the entry is cleared from the portion of the object table in the non-persistent memory. If the entry represents multiple versions of the data object, a version collection procedure is triggered. In the version collection procedure, an oldest version of the data object is selected and it is determined whether it is non-collectable. If it is determined that it is non-collectable, that version is deleted. In determining whether a data object is non-collectable, it is further determined whether it is being accessed or whether is the most recent version of the data object.

In another aspect of the present invention, a method of writing data pages in an information storage and retrieval system is described. A commit transaction or similar command is received from an application. One or more data pages to be written to a persistent memory from a non-persisent memory are selected. An address of a selected data page is written to a system write queue buffer. The selected data page is then retrieved based on addresses in the system write queue buffer. The selected data page is then stored in a disk write buffer of a writer thread. It is then determined whether to write the selected data page to the persistent memory. Finally, the address of the selected data page is adjusted.

Additional objects, features and advantages of the various aspects of the present invention will become apparent from the following description of its preferred embodiments, which description should be taken in conjunction with the accompanying drawings.

### BRIEF DESCRIPTION OF THE DRAWINGS

FIG. 1A shows a block diagram of a relational database management system (RDBMS).

FIG. 1B shows a schematic block diagram illustrating how a conventional RDBMS system handles the storage and retrieval of a BLOB 170.

FIG. 2 shows a schematic block diagram of an information storage and retrieval system 200 in accordance with a specific embodiment of the present invention.

FIG. 3A shows a flow diagram of a Write New Object Procedure 300 in accordance with a specific embodiment to the present invention.

FIGS. 3B-3E show various block diagrams of how a specific embodiment of the present invention may be implemented in a database system.

FIG. 4 shows a specific embodiment of a block diagram illustrating how different portions of the Object Table 401 maybe stored within the information storage and retrieval system of the present invention.

FIG. 5 shows a flow diagram of an Object table entry Management Procedure 500 in accordance with a specific embodiment of the present invention.

FIG. 6 shows a flow diagram of a Object Table Version Collector Procedure 600 in accordance with a specific embodiment of the present invention.

FIG. 7A shows a block diagram of a specific embodiment of a client library 750 which may be used for implementing the information storage and retrieval technique of the present invention.

FIG. 7B shows a block diagram of a specific embodiment of a database server 700 which may be used for implementing the information storage and retrieval technique of the present invention.

FIG. 8A shows a specific embodiment of a block diagram of a disk page buffer 800 which may reside in the data server cache 210 of FIG. 2.

FIG. 8B shows a block diagram of a version of a database object 880 in accordance with a specific embodiment of the present invention.

FIG. 9A shows a block diagram of a specific embodiment of a virtual memory system 900 which may be used to implement an optimized block write feature of the present invention.

FIG. 9B shows a block diagram of a writer thread 990 in accordance with a specific embodiment of the present invention.

FIG. 10 shows a flow diagram of a Cache Manager Flush Procedure 1000 in accordance with a specific embodiment of the present invention.

FIG. 11 shows a flow diagram of a Disk Manager Flush Procedure 1100 in accordance with a specific embodiment of the present invention.

FIG. 12 shows a flow diagram of a Callback Procedure 1200 in accordance with a specific embodiment of the present invention.

FIG. 13A shows a flow diagram of a Commit Transaction Procedure 1300 in accordance with a specific embodiment of the present invention.

FIG. 13B shows a block diagram of a Commit Transaction object 1350 in accordance with a specific embodiment of the present invention.

FIG. 14 shows a flow diagram of a Non-Checkpoint Restart Procedure 1400 in accordance with a specific embodiment of the present invention.

FIG. 15 shows a flow diagram of a Crash Recovery Procedure 1500 in accordance with a specific embodiment of the present invention.

FIG. 16A shows a flow diagram of a Checkpointing Restart Procedure 1600 in accordance with a specific embodiment of the present invention.

FIG. 16B shows a flow diagram of a Crash Recovery Procedure 1680 in accordance with a specific embodiment of the present invention.

FIG. 17 shows a block diagram of different regions within a persistent memory storage device 1702 that has been configured to implement a specific embodiment of the information storage and retrieval technique of the present invention.

FIG. 18 shows a block diagram of an Allocation Map entry 1800 in accordance with a specific embodiment of the present invention.

FIG. 19 shows a block diagram illustrating how a checkpointing version collector technique may be implemented in a specific embodiment of the database system of the present invention.

FIG. 20A shows a flow diagram of a Checkpointing Version Collector Procedure 2000 in accordance with a specific embodiment of the present invention.

FIG. 20B shows a flow diagram of a Flush Output Disk Page Buffer (OPB) Procedure 2080 in accordance with a specific embodiment of the present invention.

FIG. 21 shows a flow diagram of a Checkpointing Procedure 2100 in accordance with a specific embodiment of the present invention.

FIG. 22 shows a flow diagram of a Free Disk Page Procedure 2200 in accordance with a specific embodiment of the present invention.

FIG. 23 shows a flow diagram of an End Checkpoint Procedure 2300 in accordance with a specific embodiment of the present invention.

FIGS. 24A and 24B illustrate block diagrams showing how selected pages of the Persistent Object Table may be updated in accordance with a specific embodiment of the present invention.

FIG. 25 shows a flow diagram of a Flush Persistent Object Table Procedure 2500 in accordance with a specific embodiment of the present invention.

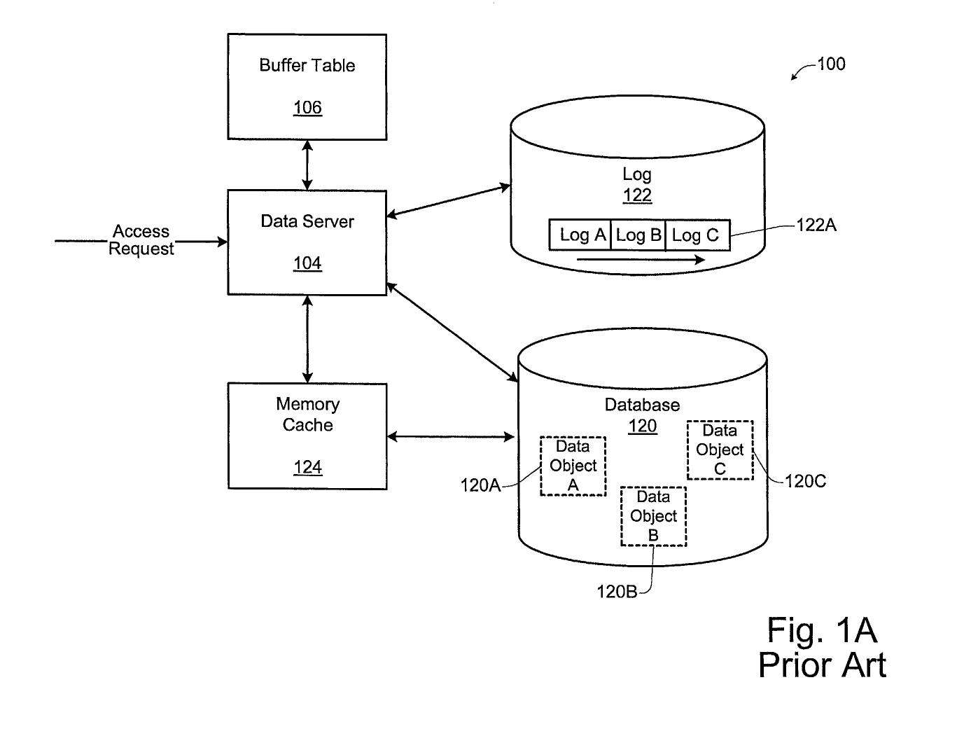

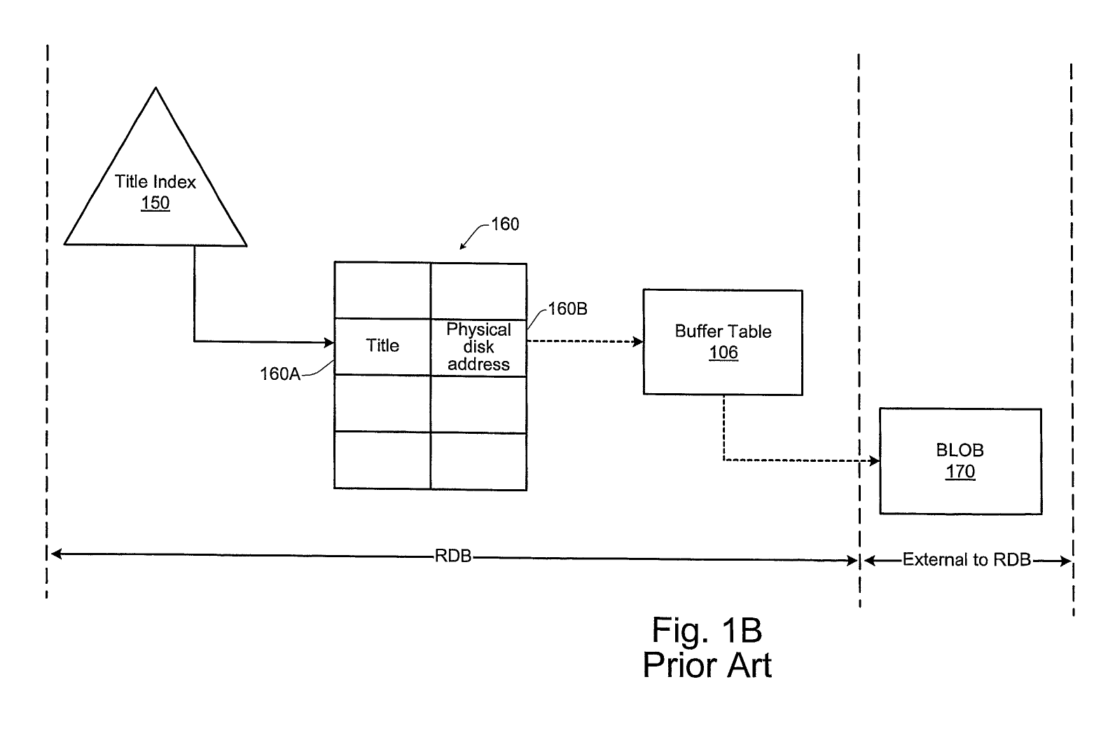

### DETAILED DESCRIPTION OF THE PREFERRED EMBODIMENTS

In accordance with at least one embodiment of the present invention, an object oriented, intrinsic versioning information storage and retrieval system is disclosed which overcomes many of the disadvantages described previously with respect to log-based RDBMS systems. Unlike conventional RDBMS systems which are based upon the physical addresses of the objects stored therein, at least one embodiment of the present invention utilizes logical addresses for mapping object locations and physical addresses of objects stored within the data structures of the system.

According to a specific embodiment, the information storage and retrieval technique of the present invention maintains a bidirectional relationship between objects. For example, if a relationship is defined from Object A to Object B, the system of the present invention also maintains an inverse relationship from Object B to Object A. In this way, referential integrity of the inter-object relationships is maintained. Thus, for example, when one object is deleted from the database, the system of the present invention internally updates all objects remaining in the database which refer to the deleted object. This feature is described in greater detail below.

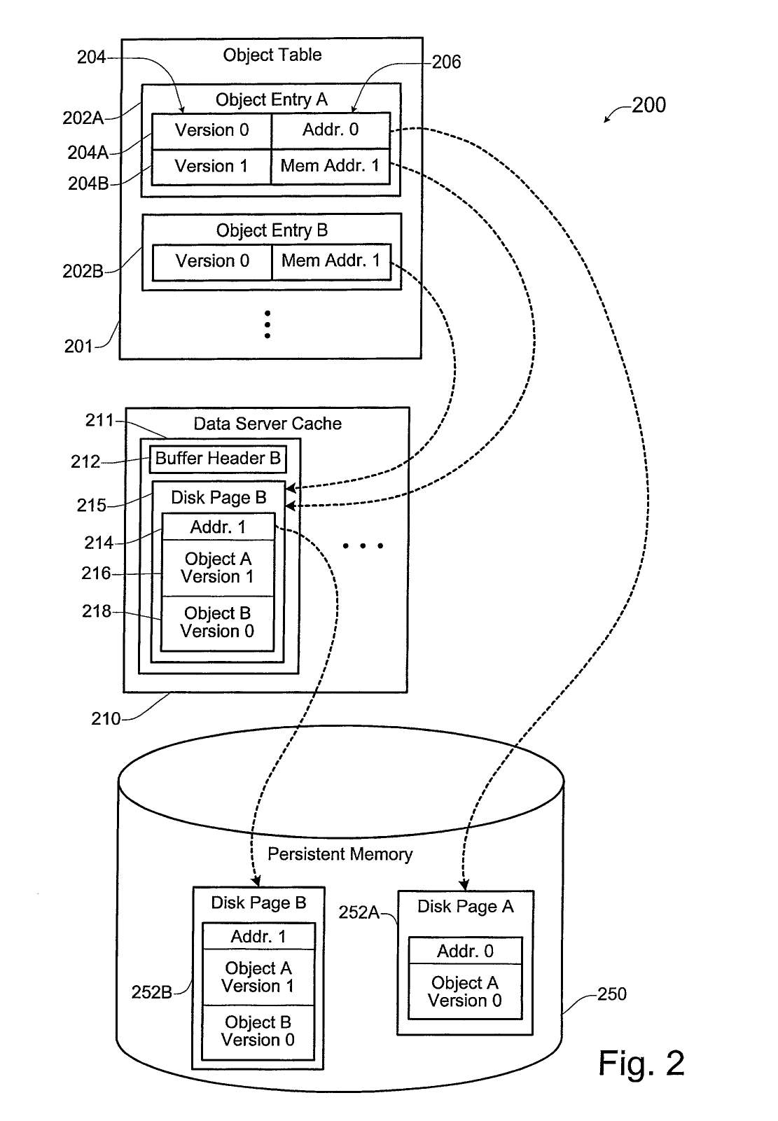

FIG. 2 shows a schematic block diagram of an information storage and retrieval system 200 in accordance with a specific embodiment of the present invention. As shown in FIG. 2, the system 200 includes a number of internal structures which provide a variety of information storage and retrieval functions, including the translation of a logical object ID to a physical location where the object is stored. The main structures of the database system 200 of FIG. 2 include at least one Object Table 201, at least one data server cache such as data server cache 210, and at least one persistent memory database 250 such as, for example, a disk drive.

As shown in FIG. 2, the Object Table 201 may include a plurality of entries (e.g. 202A, 202B, etc.). Each entry in Object Table 201 may be associated with one or more versions of objects stored in the database. For example, in the embodiment of FIG. 2, Object entry A (202A) is associated with a particular object identified as Object A. Additionally, Object Entry B (202B) is associated with a different object stored in the database, identified as Object B. As shown in Object Table 201, Object A has 2 versions associated with it, namely Version 0 (204A) and Version 1 (204B). In the example of FIG. 2, it is assumed that Version 1 corresponds to a more recent version of Object A than Version 0. Object Entry B represents a single version object wherein only a single version of the object (e.g. Object B, Version 0) is stored in the database.

As shown in the embodiment of FIG. 2, each version of each object identified in Object Table 201 is stored within the persistent memory data structure 250, and may also be stored in the data server cache 210. More specifically, Version 0 of Object A is stored on a disk page 252A (Disk Page A) within data structure 250 at a physical memory location corresponding to “Address 0”. Version 1 of Object A is stored on a disk page 252B (Disk Page B) within data structure 250 at a physical memory location corresponding to “Address 1”. Additionally, as shown in FIG. 2, Version 0 of Object B is also stored on Disk Page B within data structure 250.

When desired, one or more selected object versions may also be stored in the data server cache 210. According to a specific embodiment, the data server cache may be configured to store copies of selected disk pages located in the persistent memory 250. For example, as shown in FIG. 2, data server cache 210 includes at least one disk page buffer 211 which includes a buffer header 212, and a copy 215 of Disk Page B 252B. The copy of Disk Page B includes both Version 1 of Object A (216), and Version 0 of Object B (218).

As shown in FIG. 2, each object version represented in Object Table 201 includes a corresponding address 206 which may be used to access a copy of that particular object version which is stored in the database system 200. According to a specific embodiment, when a particular copy of an object version is stored in the data server cache 210, the address portion 206 of that object version (in Object Table 201) will correspond to the memory address of the location where the object version is stored in the data server cache 210. Thus, for example, as shown in FIG. 2, the address corresponding to Version 1 of Object A in Object Table 201 is Memory Address 1, which corresponds to the disk page 215 (residing in the data server cache) that includes a copy of Object A, Version 1 (216). Additionally, the address corresponding to Version 0 of Object B (in Object Table 201) is also Memory Address 1 since Disk Page B 215 also includes a copy of Object B, Version 0 (218).

As shown in FIG. 2, Disk Page B 215 of the sate server cache includes a separate address field 214 which points to the memory location (e.g. Addr. 1) where the Disk Page B 252B is stored within the persistent memory data structure 250.

As described in greater detail below, the system 200 of FIG. 2 may be based upon a semantic network object model. The object model integrates many of the standard features of conventional object database management systems such as, for example, classes, multiple inheritance, methods, polymorphism, etc. The application schema may be language independent and may be stored in the database. The dynamic schema capability of the database system 200 of the present invention allows a user to add or remove classes or properties to or from one or more objects while the system is on-line. Moreover, the database management system of the present invention provides a number of additional advantages and features which are not provided by conventional object database management systems (ODBMSs) such as, for example, text-indexing, intrinsic versioning, ability to handle real-time feeds, ability to preserve recovery data without the use of traditional log files, etc. Further, the database system 200 automatically manages the integrity of relationships by maintaining by-directional links between objects. Additionally, the data model of the present invention may be dynamically extended without interrupting production systems or recompiling applications.

According to a specific embodiment, the database system 200 of FIG. 2 may be used to efficiently manage BLOBs (such as, for example, multimedia data-types) stored within the database itself. In contrast, conventional ODBMS and RRBMS systems do not store BLOBs within the database itself, but rather resort to storing BLOBs in file systems external to the database. According to one implementation, the database system 200 may be configured to include a plurality of media APIs which provide a way to access data at any position through a media stream, thereby enabling an application to jump forward, backward, pause, and/or restart at any point of a media or binary stream.

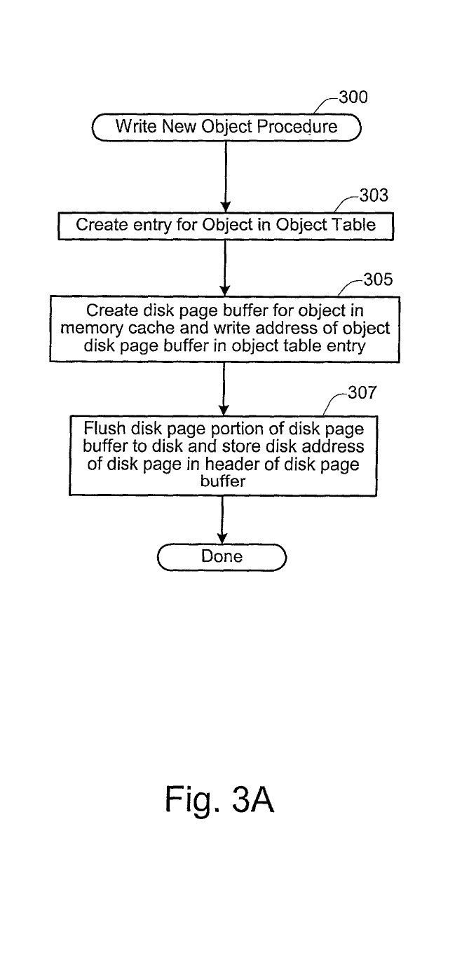

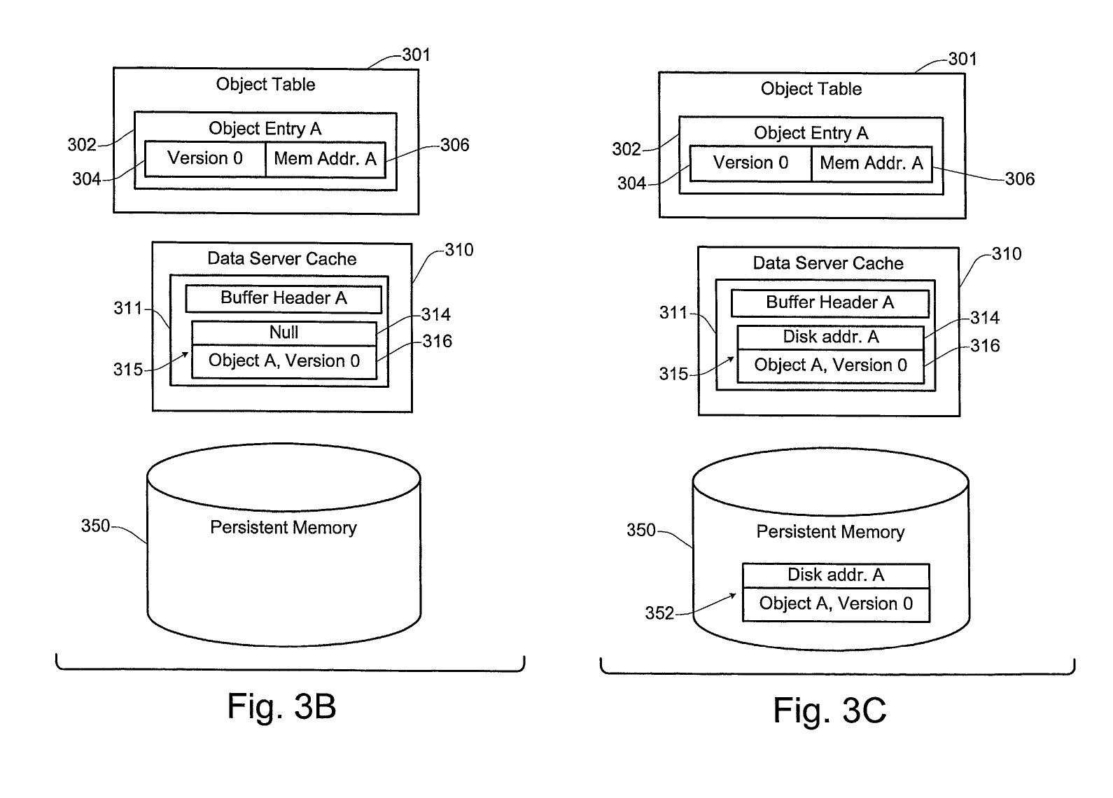

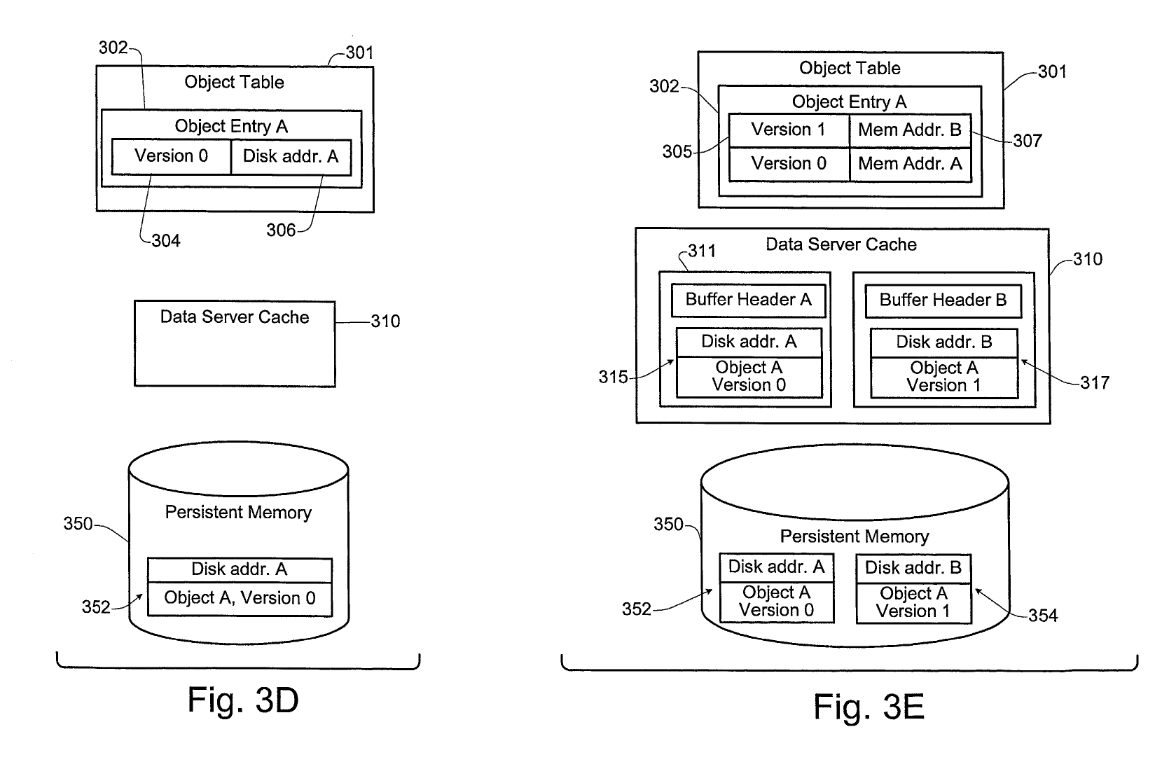

FIG. 3A shows a flow diagram of a Write New Object Procedure 300 in accordance with a specific embodiment to the present invention. According to at least one implementation, the Write New Object Procedure 300 of FIG. 3A may be implemented in an information storage and retrieval system such as that shown, for example, in FIG. 2 of the drawings. The Write New Object Procedure 300 of FIG. 3A may be used for creating and/or storing a new object or new object version in the information storage and retrieval system of the present invention. For purposes of illustration, the Write New Object Procedure of FIG. 3A will now be described with reference to FIGS. 3B-3E of the drawings.

In the following example, it is assumed that a new object (e.g. Object A, Version 0) is to be created in the information storage and retrieval system of the present invention. Initially, as shown at 303 of FIG. 3A, an entry for the new object and/or new object version is created in the Object Table 301 (FIG. 3B). Next, a disk page buffer 311 for the new object version is created (305) in the data server cache (310, FIG. 3B), and the memory address of the newly created disk page buffer (e.g. Memory Address A) is recorded in the Object Table 301.

FIG. 3B shows an example of how information is stored in a specific embodiment of the information storage and retrieval system of the present invention after having executed blocks 303 and 305 of FIG. 3A. As shown in FIG. 3B, Object Table 301 includes an entry 302 corresponding to the newly created Object A, Version 0. Additionally, as shown in FIG. 3B the data server cache 310 includes a disk page buffer 311. The disk page buffer 311 includes a disk page portion 315 which includes a copy 316 of the Object A, Version 0 object. In this example, it is assumed that the disk page buffer 311 is stored in the data server cache at a memory location corresponding to Memory Address A. In accordance with a specific implementation, the physical address corresponding to the location of the disk page 315 in the data server cache (e.g. Mem Addr. A) is stored as an address pointer 306 in Object Table 301. It will be appreciated that, according to a specific implementation, the newly created object version (e.g. Object A, Version 0) is first stored in the data server cache 310, and subsequently flushed from the data server cache to the persistent memory 350. Accordingly, as shown in FIG. 3B, for example, the disk address field 314 (corresponding to the memory address where the object version resides in the persistent memory) may be initialized to NULL since the object version has not yet been stored in the persistent memory.

Referring to FIG. 3A, once the newly created object or object version has been stored in the data server cache 310, the disk page portion (315, FIG. 3B) of the disk page buffer (311, FIG. 3B) is flushed (307) to the persistent memory 350, where a new copy of the flushed disk page is stored (see, e.g., FIG. 3C). Additionally, the disk address of the new disk page stored within the persistent memory is written into the header field 314 of the corresponding disk page 315 of the data server cache. This is shown, for example, in FIG. 3C of the drawings.

FIG. 3C shows an example of how information is stored in a database system of the present invention after having executed the Write New Object Procedure 300 of FIG. 3A. As shown in FIG. 3C, a new disk page 352 (which includes a copy of Object A, Version 0) has been stored in the persistent memory 350 at a disk address corresponding to Disk Address A. The disk address information is then passed back to the data server cache, where the disk address (e.g. Disk Address A) is written in the header portion 314 of disk page 315.

According to at least one embodiment of the present invention, when an disk page stored in the data server cache is released from the data server cache, the persistent memory address of the disk page (stored in header portion 314) is written to the address respective pointer portions 306 of corresponding object version entries in Object Table 301 which are associated with that particular disk page. This is illustrated, for example, in FIG. 3D of the drawings.

As shown in the example of FIG. 3D, it is assumed that the disk page 315 of FIG. 3C has been released from the data server cache. According to a specific embodiment, when a disk page is released from the data server cache, the persistent memory address of the disk page is written into the respective address pointer portions 306 of corresponding object version entries in Object Table 301 that are associated with the released disk page. In the example of FIG. 3C, the disk page 315 (a copy of which is stored in the persistent memory as disk page 352) includes one object version, namely Object A, Version 0. Thus, as shown in FIG. 3D, when disk page 315 is released, the value of the address pointer portion 306 is changed from Memory Address A to Disk Address A. This technique may be referred to as “swizzling”, and is generally known to one having ordinary skill in the art. Additionally, according to a specific implementation, if the disk page 315 were to include additional object versions, the address pointer portion of each of the entries in the Object Table 301 corresponding to these additional object versions would also be swizzled.

In accordance with a specific aspect of the present invention, when a new version of an object is to be stored or created in the database system of the present invention, the new version may be stored as a separate and distinct object version in the database system, and unlike conventional relational database systems, is not written over older versions of the same object. This is shown, for example, in FIG. 3E of the drawings.

In the example of FIG. 3E, it is assumed that a new version of Object A (e.g. Version 1) is to be stored in the database system shown in FIG. 3C. According to one implementation, the new object version may be created and stored in the database system of the present invention using the Write New Object Procedure 300 of FIG. 3A.

Referring to FIG. 3E, a separate Object table entry 305 corresponding to Version 1 of Object A is created and stored within Object Table 301. Additionally, a copy of Object A, Version 1 is stored in separate disk page in both the memory cache 310 and persistent memory 350. The cached disk page 317 is stored at a memory location corresponding to Memory Address B, and the persistent memory disk page 354 is stored at a memory location corresponding to Disk Address B. According to at least one embodiment, the copy of Object A, Version 1 (354) is stored at a different address location in the persistent memory than that of Object A, Version 0 (352). Similarly, the disk page 315 of the data server cache may be located at a different memory address than that of disk page 317.

According to at least one embodiment of the present invention, the data server cache 310 need not necessarily include a copy of each version of a given object. Moreover, at least a portion of the object versions or disk pages cached in the data server cache may be managed by conventional memory caching algorithms, which are commonly known to one having ordinary skill in the art. Additionally, it will be appreciated that each disk page of the database system of the present invention may be configured to store multiple object version, as shown for example in FIG. 2.

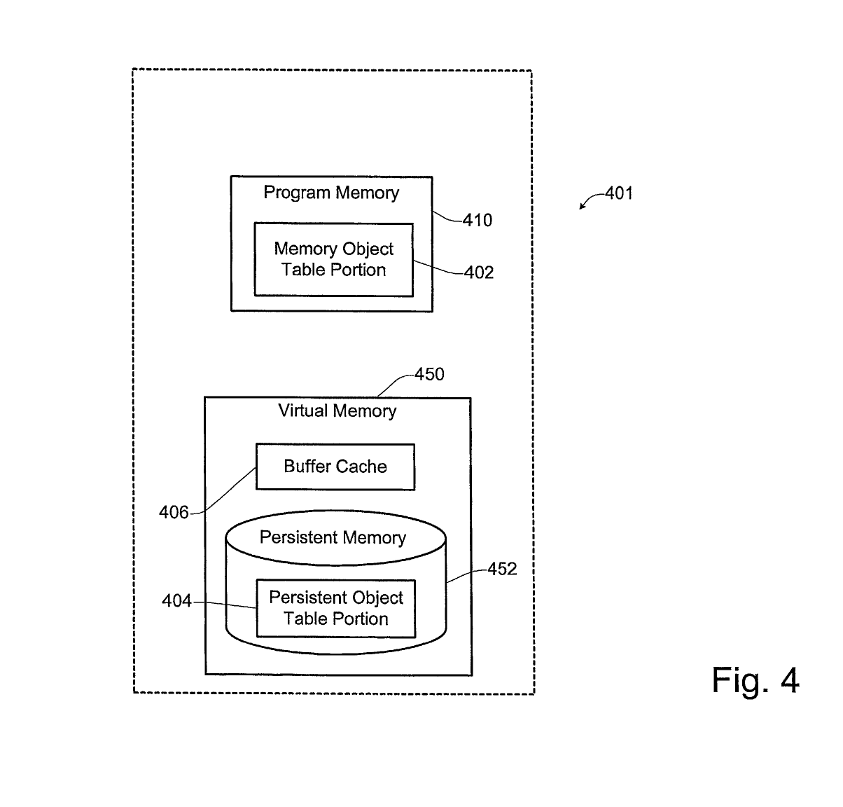

FIG. 4 shows a specific embodiment of a block diagram illustrating how different portions of the Object Table 401 maybe stored within the information storage and retrieval system of the present invention. According to a specific implementation, Object Table 401 may correspond to the Object Table 201 illustrated in FIG. 2. As explained in greater detail below, a first portion 402 (herein referred to as the Memory Object Table or MOT) of the Object Table 401 may be located within program memory 410, and a second portion 404 (herein referred to as the Persistent Object Table or POT) of the Object Table 401 may be located in virtual memory 450. According to at least one implementation, program memory 410 may include volatile memory (e.g., RAM), and virtual memory 450 may include a memory cache 406 as well as persistent memory 404.

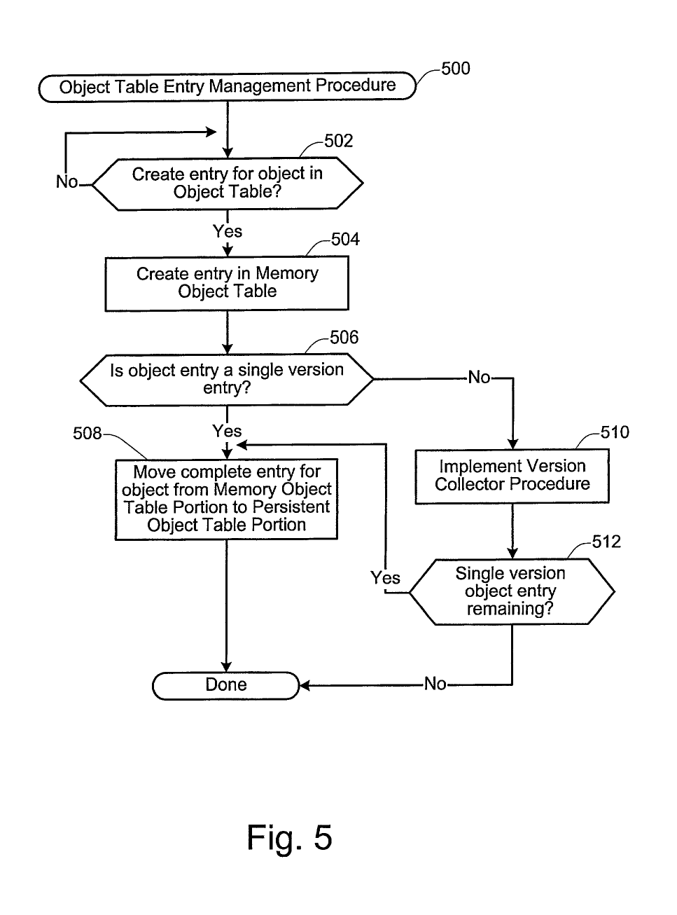

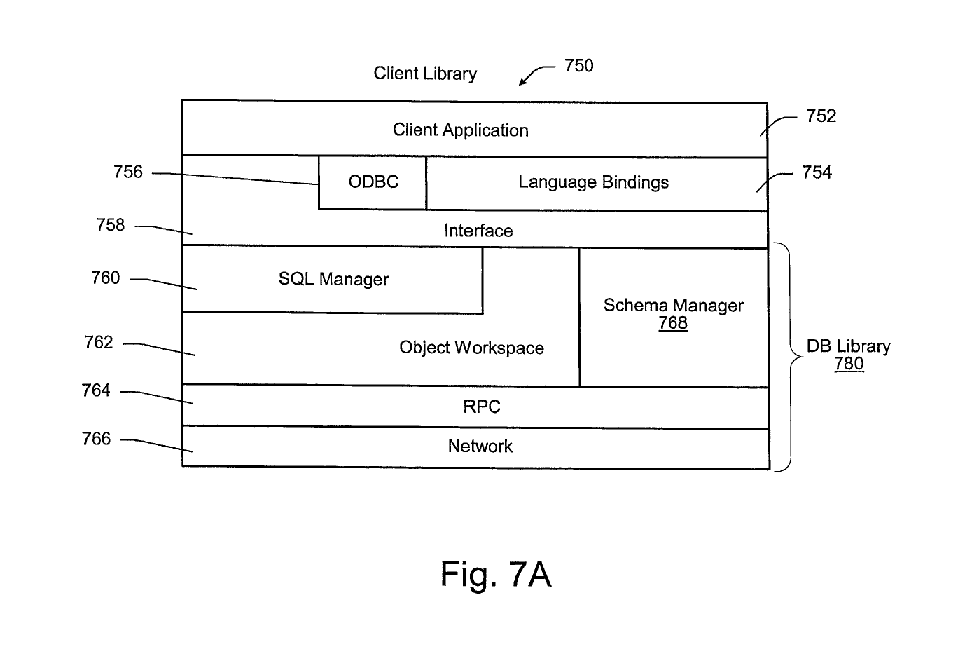

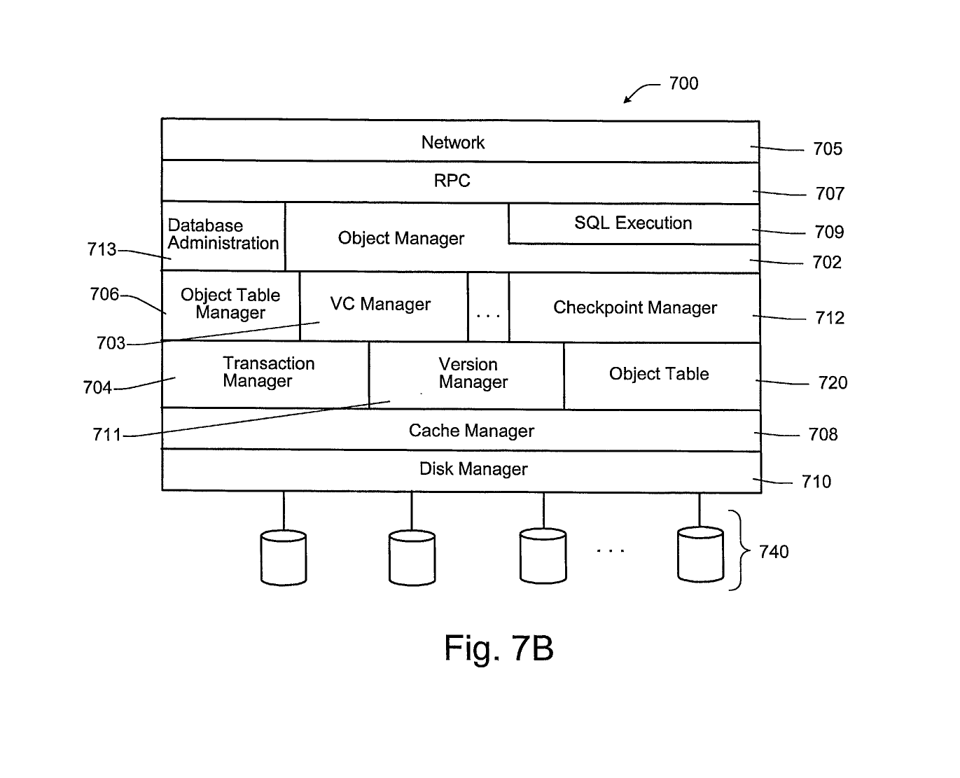

FIG. 5 shows a flow diagram of an Object table entry Management Procedure 500 in accordance with a specific embodiment of the present invention. The procedure 500 of FIG. 5 may be used, for example, for managing the location of where object entries are stored in Object Table 401 of FIG. 4. Thus, for example, as described in greater detail below, a first portion of object entries may be stored in the Persistent Object Table portion of the Object Table, while a second portion of object entries may be stored in the Memory Object Table portion of the Object Table. Management of the Object Table entries may be performed by an Object Table Manager, such as that described with respect to FIG. 7B of the drawings.

The procedure of FIG. 5 will now be described with respect to FIG. 4 of the drawings. Initially, as shown as 502 of FIG. 5, a determination is made as to whether a new object entry for a particular object version is to be created in the Object Table (401, FIG. 4). For example, when a new version of a particular object is to be stored in the information storage and retrieval system of the present invention, a new entry corresponding to the new object version is created in the Object Table 401.

If it is determined that a new object version entry for a particular object is to be created, then a new entry for the object version is created (504) in the Memory Object Table 402 portion of the Object Table. A determination is then made (506) as to whether the created or selected object version entry corresponds to a single version entry. In accordance with at least one embodiment of the present invention, a single version entry represents an object having only a single version associated therewith. If a particular object has two different versions associated with it in the database, the object does not represent a single version object.

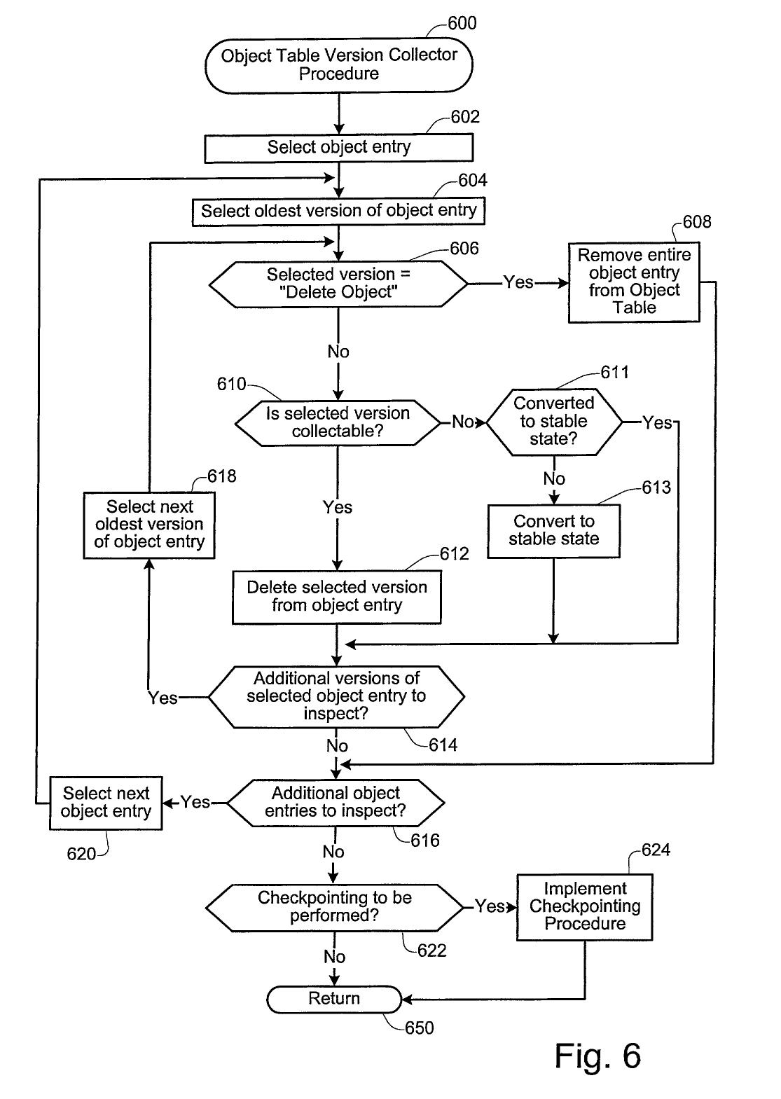

If it is determined that the selected object version entry corresponds to a single version entry, then the entire object entry is moved from the Memory Object Table portion 402 to the Persistent Object Table portion 404 of the Object Table 401. If, however, it is determined that the selected object version entry does not correspond to a single version entry, then a Version Collector Procedure, such as, for example, Version Collector Procedure 600 of FIG. 6, may be implemented (510) in order to remove obsolete objects or object versions from the database. According to a specific implementation, the Version Collector Procedure may be configured as an asynchronous process which may run independently from the Object table entry Management Procedure of FIG. 5.

After the Version Collector Procedure has been performed, there is a possibility that older versions of the selected object entry have been deleted or removed from the database system. Accordingly, at 512 a determination is made as to whether a single version of the selected object entry remains. If it is determined that the selected object entry cannot be reduced to a single version, then the object entry will remain in the Memory Object Table portion of the Object Table. If, however, the selected object entry has been reduced to a single version entry, then, as shown at 508, the object entry is moved from the Memory Object Table portion to the Persistent Object Table portion of the Object Table.

According to one implementation, only single version object entries may be stored in the Persistent Object Table portion. If an object entry is not a single version entry, it is stored in the Memory Object Table portion. Thus, for example, according to a specific implementation, the oldest version of an object will be stored in the Persistent Object Table portion, while the rest of the versions of that object will be stored in the Memory Object Table portion.

According to at least one embodiment, the database system includes an Object Table Manager (such as, for example, Object Table Manager 706 of FIG. 7B) which manages movement of object entries between the Memory Object Table portion and the Persistent Object Table portion of the Object Table. The Object Table Manager may also be used to locate a particular object or object version entry in the Object Table. According to a specific implementation, the Object Table Manager first searches the Memory Object Table portion for the desired object version entry, and, if unsuccessful, then searches the Persistent Object Table portion for the desired object version entry.

FIG. 6 shows a flow diagram of an Object Table Version Collector Procedure 600 in accordance with a specific embodiment of the present invention. According to a specific embodiment, a separate thread of the Object Table Version Collector Procedure may be implemented independently and asynchronously from other procedures described in this application, such as, for example, the Object table entry Management Procedure. According to at least one implementation, the Version Collector Procedure 600 may be initiated or called by the Version Collector Manager (e.g. 703, FIG. 7B), and may be implemented by a system manager such as, for example, the Object Manager 702 and/or Object Table Manager 706 of FIG. 7B.

According to different embodiments, the Object Table Version Collector Procedure may either be implemented manually or automatically. For example, a system administrator may chose to manually implement the Object Table Version Collector Procedure to free used memory space in the database system. Alternatively the Object Table Version Collector Procedure may be automatically implemented in response to a determination that the Memory Object Table has grown too large (e.g. has grown by more than 2 megabytes since the last Version Collection operation), or in response to a determination that the limit of the storage space of the persistent memory has nearly been reached (e.g. less than 5% of available disk space left).

Thus it will be appreciated that one function of the Object Table Version Collector Procedure is to identify and remove obsolete object entries or obsolete object version entries from the Object Table. According to a specific implementation, an obsolete object or object version maybe defined as an old version (or object) which is also collectable. A collectable object version is one which is not the most recent version of the object and is not currently being used by a user or system resource.

According to a specific implementation, the Object Table Version Collector Procedure 600 may cycle through each object entry in the Object Table in order to remove any obsolete objects or object versions which are identified. As shown at 602 of FIG. 6, a particular object entry from the Object Table is selected. If the selected object entry has more than one version associated with it, the oldest version of the object entry is selected first (604). A determination is then made (606) as to whether the selected object entry is to be deleted. According to a specific embodiment, an object entry in the Object Table may be marked for deletion by creating and storing a “delete object” version of that object. In the example of FIG. 6, it is assumed that a “delete object” version will always be the newest version of a particular object. Therefore, if the oldest version of the object corresponds to the “delete object” version, then it may be assumed that no older versions of the selected object exist. Accordingly, as shown at 608, the entire object entry may be removed from the Object Table. Thereafter, the Object Table Version Collector Procedure may proceed with inspecting any remaining object entries in the Object Table (if any).

If it is determined that the selected object version does not correspond to a “delete object” version, then a determination is made (610) as to whether the selected version is collectable. According to a specific implementation, a particular object version is not collectable if it is in use by at least one user and/or it is the most recent version of that object. If it is determined that the selected version is collectable, the selected version may then be deleted (612) from the object entry. If, however, it is determined that the selected object version is not collectable, then the header of the selected object version is inspected in order to determine (611) whether the selected object version has been converted to a stable state.

According to a specific embodiment, when a transaction involving a new object version is created in the database system, the new object version is assigned a transaction ID by the Transaction Manager. Once the object version has been written to the persistent memory, and a new object version entry for the new object version has been created in the Object Table, the transaction ID for that object version may then be converted to a valid version ID.

According to a specific embodiment, an object version has been converted to a stable state if it has been assigned or mapped to a version ID. If the selected object version has not been converted to a stable state, it will have associated with it a transaction ID. Thus, in the example of FIG. 6, if it is determined (611) that the selected version has not yet been converted to a stable state, the selected object version may then be converted (613) to a stable state, for example, by remapping the transaction ID to a version ID. Further, according to a specific implementation, conversion of the transaction ID to a version ID may be performed after verifying that a copy of the selected object version has been stored in the persistent memory.

If, the selected object version has already been converted to a stable state (e.g. already has a valid version ID), then no further action is performed upon the selected object version, and the Object Table Version Collector Procedure may proceed by selecting and analyzing additional versions of the selected object entry.

Once analyzing a selected object version entry for version collection, the Object Table Version Collector Procedure determines (614) whether there are additional versions of the selected object entry to analyze. If other versions of the selected object entry exist, then the next oldest version of the object entry is selected (618) for analysis. If there are no additional versions of the selected object entry to analyze, the Object Table Version Collector Procedure determines (616) whether there are additional object entries in the Object Table to analyze. If there are additional object entries requiring analysis, a next object entry is selected (620), whereupon each version associated with the newly selected object entry may then be analyzed for version collection.

After the Object Table Version Collector Procedure has processed all desired Object Table entries, it then determines (622) whether a Checkpointing Procedure should be initiated or performed upon the Object Table data. According to a specific embodiment, the decision as to whether a Checkpointing Procedure should be initiated may depend on a variety of factors. For example, it may be desirable to implement a Checkpointing Procedure in response to detecting that a threshold amount of new stable data has been generated, or that a threshold amount of unstable data has either been marked for deletion or has been converted to stable data. According to one embodiment, this threshold amount may be characterized in terms of an amount of data which may cause a recovery time of the database system (e.g. following a system crash) to exceed a desired time value. For example, it may be desired to implement a Checkpointing Procedure in order to ensure that a crash recovery procedure could be completed within 10-15 minutes following a system crash. Thus, in one example, the threshold amount of data may be set equal to about 500 megabytes for each disk in the persistent memory.

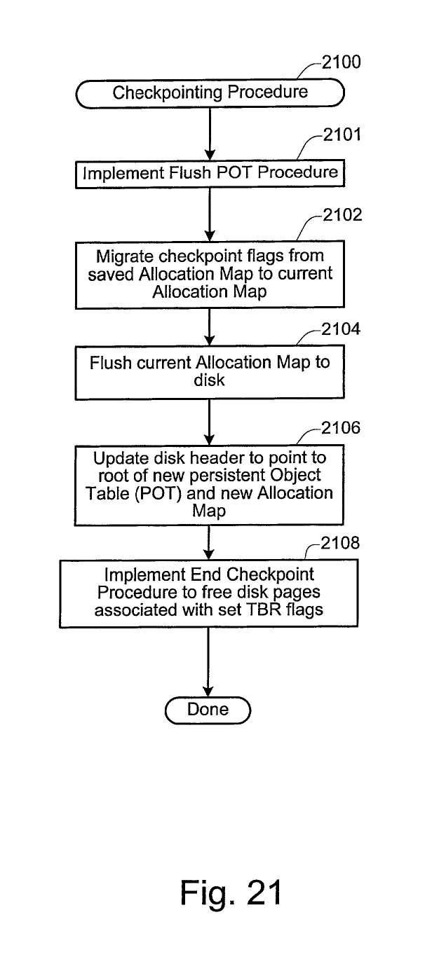

As shown in FIG. 6, if it is determined that a threshold amount of data in the Object Table has been modified, a Checkpointing Procedure, such as that shown in FIG. 21 of the drawings, may then be implemented (624) in order to checkpoint the current data in the Object Table. After completion of the checkpointing procedure, or in the event that no Checkpointing Procedure is to be performed on the Object Table data, the Object Table Version Collector Procedure 600 may remain idle until it is called once again for version collection analysis of Object Table entries.

FIG. 7A shows a block diagram of a specific embodiment of a client library 750 which may be used in implementing the information storage and retrieval technique of the present invention. As shown in FIG. 7A, the client library 750 includes a database (DB) library portion 780 which provides a mechanism for communicating with a database server of the present invention such as that shown, for example, in FIG. 7B.

The client library may be linked to application programs 752 either directly through a native API 758, or through language bindings 754 such as, for example, Java, C++, Eiffel, Python, etc. A structured query language (SQL) component 760 may also be accessed through these bindings or through open database connectivity (ODBC) 756.

Further, as shown in the embodiment of FIG. 7A, the client library includes an object workspace 762 which may be used for caching objects for fast access. The client library may also include a schema manager 768 for handling schema modifications and for validating updates against the application schema. The RPC layer 764 and network layer 766 may be used to control the connections to the database server and to control the transfer of information between the client and server.

FIG. 7B shows a block diagram of a specific embodiment of a database server 700 which may be used in implementing the information storage and retrieval technique of the present invention. According to at least one embodiment, the database server 700 may be configured as an object server, which receives and processes object updates from clients and also delivers requested objects to the clients.

As shown in FIG. 7B, the database server includes an Object Manager 702 for managing objects stored in the database. In performing its functions, the Object Manager may rely on internal structures, such as, for example, B-trees, sorted lists, large objects (e.g. objects which span more than one disk page), etc. According to a specific embodiment, Object Manager 702 may be responsible for creating and/or managing user objects, user indexes, etc. The Object Manager may make calls to the other database managers in order to perform specific management functions. The Object Manager may also be responsible for managing conversions between user visible objects and internal database objects.

The database server may also include an Object Table Manager 706, which may be responsible for managing Object Table entries, including object entries in both the Memory Object Table portion and Persistent Object Table portion of the Object Table.

The database server may also include a Version Collection (VC) Manager 703, which may be responsible for managing version collection details such as, for example, clearing obsolete data, compaction of non-obsolete data, cleaning up Object Table data, etc. According to one implementation, both the VC manager and the Object Manager may call upon the Object Table Manager for performing specific operations on data stored in the Object Table.

The database server may also include a Transaction Manager 704, which may be responsible for managing transaction operations such as, for example, committing transactions, stalling transactions, aborting transactions, etc. According to a specific implementation, a transaction may be defined as an atomic update of a portion of data in the database. The Transaction Manager may also be responsible for managing serialized and consistent updates of the database, as well as managing atomic transactions to help insure recovery of the database in the event of a software or disk crash.

The database server may also include a Cache Manager 708, which may be responsible for managing virtual memory operations. This may include managing where specific data is to be stored in the virtual memory (e.g. either on disk or in the data server cache). According to a specific implementation, the Cache Manager may communicate with the Disk Manager 710 for accessing data in the persistent memory. The Cache Manager and Disk Manager may work together to ensure parallel reads and writes of the data across multiple disks 740. The Disk Manager 710 may be responsible for disk I/O operations, and may also be responsible for load balancing operations between multiple disks 740 or other persistent memory devices.

The database server 700 may also include an SQL execution engine 709 which may be configured to process SQL requests directly at the database server, and to return the desired results to the requesting client.

The database server 700 may also include a Version Manager 711 which may be responsible for providing consistent, non-blocking read access to the database data at anytime, even during updates of the database data. This feature is made possible by the intrinsic versioning architecture of the database server of the present invention.

If desired, the database server 700 may also include a Checkpoint Manager 712 which may be responsible for managing checkpointing operations performed on data within the database. According to a specific embodiment, the VC Manager 704 and Checkpoint Manager 712 may work together to automatically reclaim the disk space used by obsolete versions of objects that have been deleted. The Checkpoint Manager may also be responsible for handling the checkpoint mechanism that identifies the stable data in the persistent memory 740. This helps to guarantee a fast restart of the database server after a crash, which, according to at least one embodiment, may be independent of the amount of data stored in the database.

As described previously, the database server 700 includes an Object Table 720 which provides a mapping between the logical object identifiers (OIDs) and the physical address of the objects stored in the database.

It will be appreciated that alternate embodiments of the database server and client library of the present invention may not include all the elements and/or features described in the embodiments of FIGS. 7A and 7B. The specific configurations of such alternate embodiments may vary depending upon the desired specifications, and will be readily apparent to one having ordinary skill in the art.

According to at least one embodiment, the database system of the present invention may be designed or configured as a client-server system, wherein applications built on top of a client database library talk with a database server using database Remote Procedure Calls (RPCs). A database client implemented on a client device may exchange objects with the database server. In one implementation, objects which are accessed through the client library may be cached in the client workspace for fast access. Moreover, according to one implementation, only the essential or desired portions of the data pages are provided by the database server to the client. Unnecessary data such as, for example, index pages, internal structures, etc., are not sent to the client machine unless specifically requested. Additionally, it will be appreciated that the information storage and retrieval technique of the present invention differs greatly from that of conventional RDBMS techniques which only return a projection back to the client rather than objects which can be modified directly by the client workspace.

Additionally, according to a specific embodiment, the database server of the present invention may be implemented on top of kernel threads, and may be configured to scale linearly as new CPUs or new persistent memory devices (e.g. disks) are added to the system.

The unique architecture of the present invention provides a number of advantages which are not provided by conventional ODBMS or RDBMS systems. For example, administrative tasks such as, for example, adding or removing disks, running a parallel backup, etc., can be performed concurrently during database read/write/update transaction activity without incurring any significant system performance degradation.

Further, unlike conventional RDBMS systems which use transaction log file techniques to ensure database integrity, the information storage and retrieval system of the present invention may be configured to achieve database integrity without relying upon transaction logs or conventional transaction log file techniques. More specifically, according to a specific implementation, the database server of the present invention is able to maintain database integrity without performing any transaction log activity. Moreover, the intrinsic versioning feature of the present invention may be used to ensure database recovery without incurring overhead due to log transaction operations.

According to one embodiment, intrinsic versioning is the automatic generation and control of object versions. According to traditional database techniques, when changes or updates are to be performed upon objects stored in a conventional database, the updated data must be written over the old object data at the same physical location in the database which has been allocated for that particular object. This feature may be referred to as positional updating. In contrast, using the technique of the present invention, when data relating to a particular object has been changed or modified, a copy of the new object version may be created and stored in the database as a separate object version, which may be located at a different disk location than that of any previously saved versions of the same object. In this way, the database system of the present invention provides a mechanism for implementing non-positional data updates.

When selected object versions or disk pages are to be deleted or removed from the database, a version collection mechanism of the present invention may be implemented to reclaim available disk space. According to a specific implementation, the version collection mechanism preserves the most recent version of an object as well as the versions which have been explicitly saved, and reclaims disk space allocated to obsolete object versions or versions which have been marked for deletion.

Another advantage of the intrinsic versioning mechanism of the present invention is that it provides a greater parallelism for read intensive applications. For example, a user or application is able to access the database consistently without experiencing locking or hanging. Moreover, the read access operations will not affect concurrent updates of the desired data. This helps prevent inconsistent data from being accessed by other users or applications (commonly referred to as “dirty reads”).

A further advantage of the intrinsic versioning mechanism of the present invention is that it provides for historical versioning access. For example, a user is able to access previous versions of the database, compare changes, identify deleted or inserted objects between different versions of the database, etc.

According to a specific embodiment, the database server of the present invention may be configured as a general purpose object manager, which operates as a back-end server that manages a repository of persistent objects. Client applications may connect to the server through a data network or through a local transport. The database server of the present invention may be configured to ensure that all that objects stored therein remain available in a consistent state, even in the presence of system failures. Additionally, when server clients access a shared set of objects simultaneously in a read or write mode, the database server of the present invention may be configured to ensure that each server client gets a consistent view of the database objects.

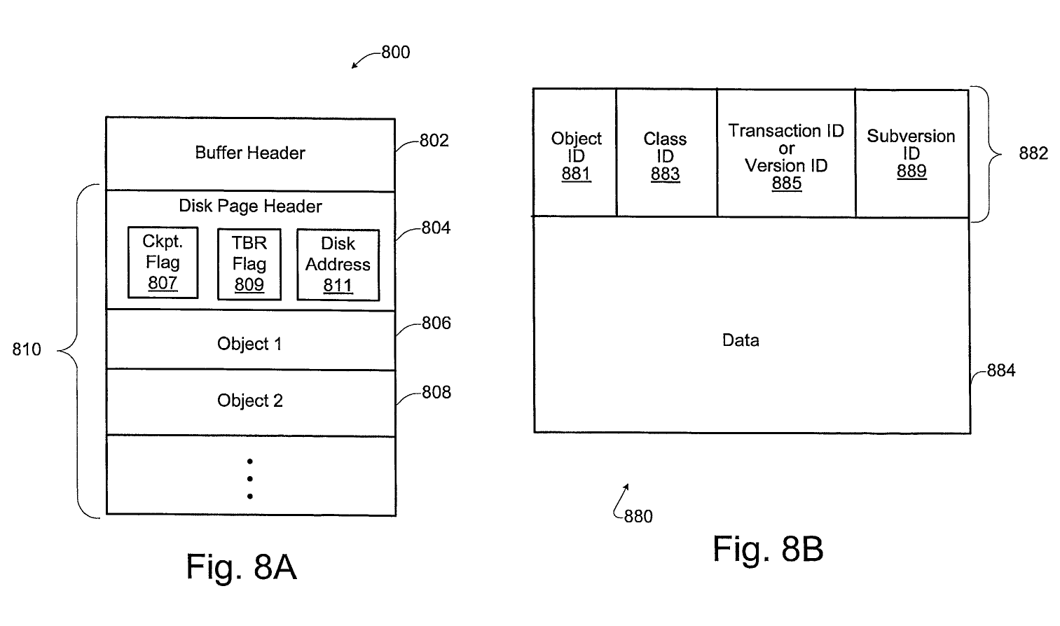

FIG. 8A shows a specific embodiment of a block diagram of a disk page buffer 800 which may be used, for example, for implementing the disk page buffer 211 of FIG. 2. As shown in FIG. 8A, the disk page buffer 800 includes a buffer header portion 802 and a disk page portion 810. The disk page portion 810 includes a disk page header portion 804, and may include copies of one or more different object versions (e.g. 806, 808). According to a specific embodiment, the disk page header portion 804 includes a plurality of different fields, including, for example, a Checkpoint Flag field 807, a “To Be Released” (TBR) Flag field 809, and a disk address field 811. The functions of the Checkpoint Flag field and TBR flag field are described in greater detail in subsequent sections of this application. The disk address field 811 may be used for storing the address of the memory location where the corresponding disk page is stored in the persistent memory.

According to a specific implementation, the disk page buffer 800 may be configured to include one or more disk pages 810. In the embodiment of FIG. 8A, the disk page buffer 800 has been configured to include only one disk page 810, which, according to specific implementations, may have an associated byte size of 4 or 8 bytes, for example.

FIG. 8B shows a block diagram of a version of a database object 880 in accordance with a specific embodiment of the present invention. According to a specific implementation, each of the object versions 806, 808 of FIG. 8A may be configured in accordance with the object version format shown in FIG. 8B.

Thus, for example, as shown in FIG. 8B, object 880 includes a header portion 882 and a data portion 884. The data portion 884 of the object 880 may be used for storing the actual data associated with that particular object version. The header portion includes a plurality of fields including, for example, an Object ID field 881, a Class ID field 883, a Transaction ID or Version ID field 885, a Sub-version ID field 889, etc. According to a specific implementation, the Object ID field 881 represents the logical ID associated with that particular object. Unlike conventional RDBMS systems which require that an Object Be identified by its physical address, the technique of the present invention allows objects to be identified and accessed using a logical identifier which need not correspond to the physical address of that object. In one embodiment, the Object ID may be configured as a 32-bit binary number.

The Class ID field 883 may be used to identify the particular class of the object. For example, a plurality of different object classes may be defined which include user-defined classes as well as internal structure classes (e.g., data pages, B-tree page, text page, transaction object, etc.).

The Version ID field 885 may be used to identify the particular version of the associated object. The Version ID field may also be used to identify whether the associated object version has been converted to a stable state. For example, according to a specific implementation, if the object version has not been converted to a stable state, field 885 will include a Transaction ID for that object version. In converting the object version to a stable state, the Transaction ID may be remapped to a Version ID, which is stored in the Version ID field 885.

Additionally, if desired, the object header 882 may also include a Subversion ID field 889. The subversion ID field may be used for identifying and/or accessing multiple copies of the same object version. According to a specific implementation, each of the fields 881, 883, 885, and 889 of FIG. 8B may be configured to have a length of 32 bits, for example.

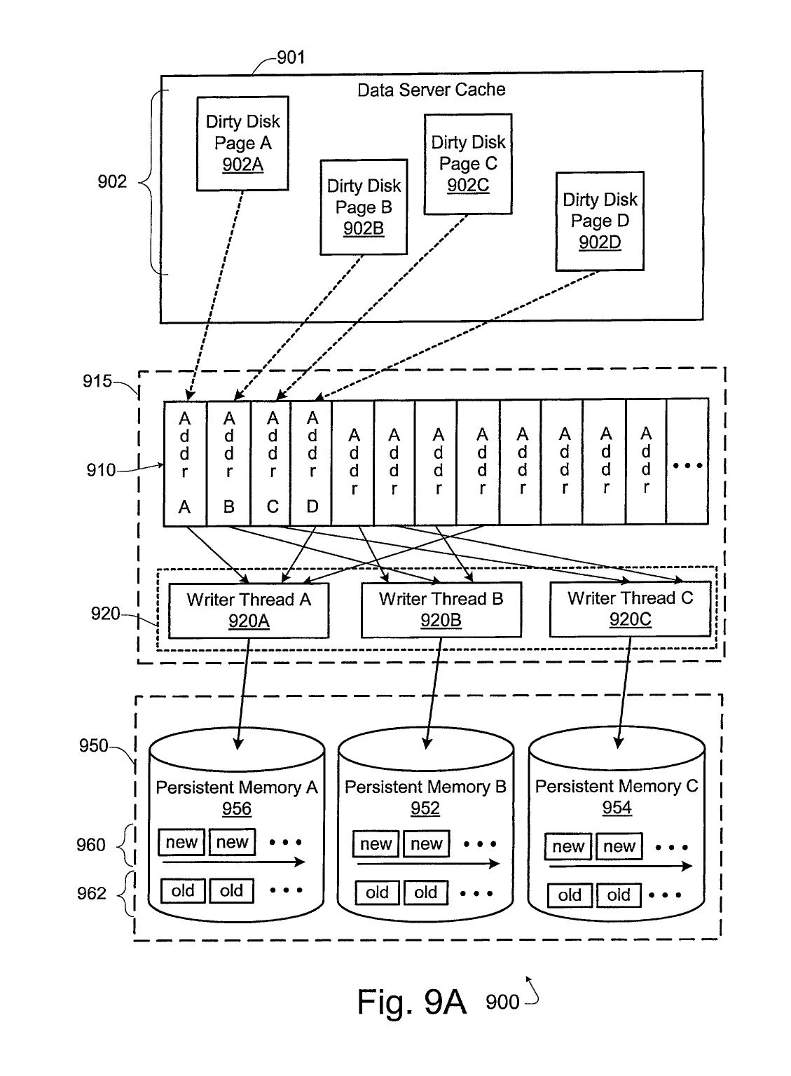

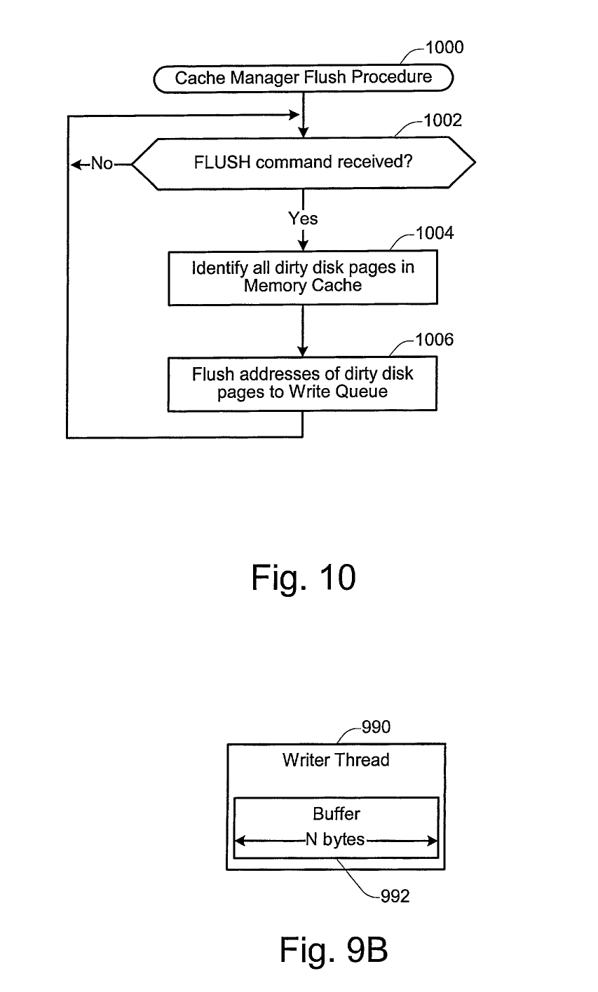

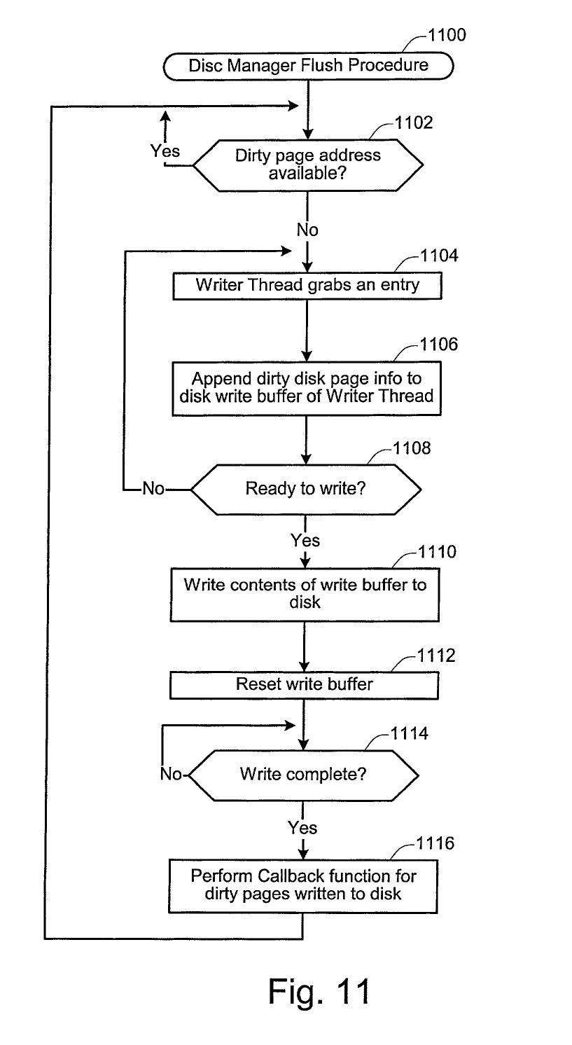

FIG. 9A shows a block diagram of a specific embodiment of a virtual memory system 900 which may be used to implement an optimized block write feature of the present invention. As shown in the embodiment of FIG. 9A, the virtual memory system 900 includes a data server cache 901, write optimization data structures 915, and persistent memory 950, which may include one or more disks or other persistent memory devices. In the embodiment of FIG. 9A, the write optimization data structures 915 include a Write Queue 910 and a plurality of writer threads 920. The functions of the various structures illustrated in FIG. 9A are described in greater detail with respect to FIGS. 10-12 of the drawings.

Generally, the addresses of dirty disk pages 902 (which are stored in the data server cache 901) are written into the Write Queue 910. According to a specific embodiment, a dirty disk page may be defined as a disk page in the data server cache which is inconsistent with the corresponding disk page stored in the persistent memory. The plurality of writer threads 920 continuously monitor the Write Queue for new dirty disk page addresses. According to a specific embodiment, the writer threads 920 continuously compete with each other to grab the next available dirty disk page address queued in the Write Queue 910. When a write thread grabs or fetches an address from the Write Queue, the writer thread copies the dirty disk page corresponding to the fetched address into an internal write buffer. The writer thread is able to queue a plurality of dirty disk pages in its internal write buffer. According to a specific implementation, the maximum size of the write buffer may be set equal to the maximum allowable block size permitted for a single write request to a specific persistent memory device. When the write buffer becomes full, the writer thread may perform a single block write request to a selected persistent memory device of all dirty disk pages queued in the write buffer of that writer thread. In this way, optimized block writing of data to one or more persistent memory devices may be achieved.

FIG. 10 shows a flow diagram of a Cache Manager Flush Procedure 1000 in accordance with a specific embodiment of the present invention. According to a specific implementation, the Cache Management Flush Procedure 1000 may be configured as a process in the database server which runs asynchronously from other processes such as, for example, the Disk Manager Flush Procedure 1100 of FIG. 11.

Initially, as shown at 1002 of FIG. 10, the Cache Manager Flush Procedure waits to receive a FLUSH command. According to a specific implementation, the FLUSH command may be sent by the Transaction Manager. Once the Cache Manager Flush Procedure has received a FLUSH command, it identifies (1004) all dirty disk pages in the data server cache. According to one implementation, a dirty disk page may be defined as a disk page which includes at least one new object that is inconsistent with the corresponding disk page data stored in the persistent memory. It is noted that a dirty disk page may include multiple object versions. In one implementation, the Transaction Manager may be responsible for keeping track of the dirty disk pages stored in the data server cache. After the dirty disk pages have been identified, the addresses of the identified dirty disk pages are then flushed (1006) to the Write Queue 910. Thereafter, the Cache Manager Flush Procedure waits to receive another FLUSH command.

FIG. 11 shows a flow diagram of a Disk Manager Flush Procedure 1100 in accordance with a specific embodiment of the present invention. According to one embodiment, a separate thread or process of the Disk Manager Flush Procedure may be implemented at each respective writer thread (e.g. 920A, 920B, 920C, etc.) running on the database server. Further, according to at least one embodiment, each writer thread may be configured to write to a designated disk or persistent memory device of the persistent memory. For purposes of illustration, it will be assumed that the Disk Manager Flush Procedure 1100 is being implemented at the Writer Thread A 920A of FIG. 9A.

As shown at 1102 of FIG. 11, the Writer Thread A continuously monitors the Write Queue 910 for an available dirty page address. As illustrated in the embodiment of FIG. 9A, each of the writer threads 920A-C compete with each other to grab dirty disk page addresses from the Write Queue as they become available. According to a specific embodiment, the Write Queue may be configured as a FIFO buffer.

When the writer thread detects an available entry in the Write Queue 910, the writer thread grabs (1104) the entry and identifies the dirty disk page address associated with that entry. Once the address of the dirty disk page has been identified, the writer thread copies desired information from the identified dirty disk page (stored in the data server cache 901), and appends (1106) the dirty disk page information to a disk write buffer of the writer thread. An example of a disk write buffer is illustrated in FIG. 9B of the drawings.

FIG. 9B shows a block diagram of a writer thread 990 in accordance with a specific embodiment of the present invention. As illustrated in FIG. 9B, the writer thread 990 includes a disk write buffer 992 for storing dirty disk page information that is to be written to the persistent memory. According to a specific implementation, the size (N) of the writer thread buffer 992 may be configured to be equal to the maximum allowable byte size of a block write operation to a specified disk or other persistent memory device. Referring to FIG. 9A, for example, if the maximum block write size for a write operation of disk 956 is 128 kilobytes, then the size of the writer thread buffer 992 may be configured to be 128 kilobytes. Thereafter, when the writer thread buffer 992 becomes filled with dirty page data, it may write the entire contents of the buffer 992 to persistent memory A device 956 during a single block write operation. In this way, optimization of block disk write operations may be achieved.

Returning to FIG. 11, after the write thread has appended the dirty disk page information to its disk write buffer, a determination is then made (1108) as to whether the writer thread is ready to write the data from its buffer to the persistent memory (e.g. persistent memory A 956). According to a specific implementation, thread writer thread may be ready to write its buffered data to the persistent memory in response to determining either that (1) the writer thread buffer has become full or has reached the maximum allowable block write size, or (2) that the Write Queue 910 is empty or that no more dirty disk page addresses are available to be grabbed. If it is determined that the writer thread is not ready to write its buffered data to the persistent memory, then the writer thread grabs another entry from the Write Queue and appends the dirty disk page information to its disk write buffer.

When the writer thread determines that it is ready to write its buffered dirty page information to the persistent memory, it performs a block write operation by writing the contents of its disk write buffer 992 to the designated persistent memory device (e.g. persistent memory A 956). According to a specific implementation, block writes of dirty disk pages may be written to the disk in a consecutive and sequential manner in order to minimize disk head movement. This feature is discussed in greater detail below. Additionally, as described above, the writing of the contents of the disk write buffer to the disk may be performed during a single disk block write operation.

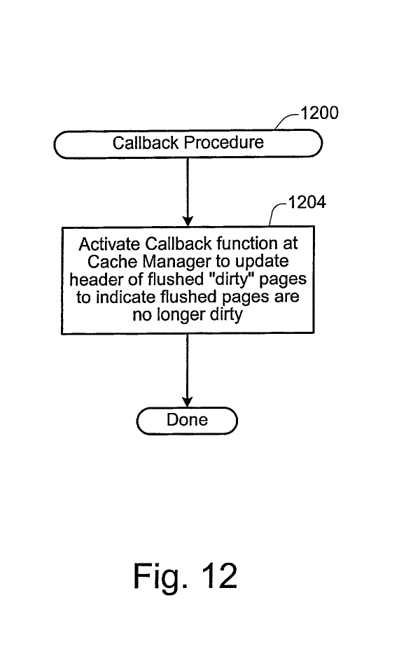

According to a specific implementation, after the contents of the writer thread buffer have been written to the disk, the disk write buffer may be reset (1112), if desired. At 1114 a determination may then be made as to whether the block write operation has been completed. According to a specific embodiment, the Disk Manager may be configured to make this determination. Once it is determined that the disk block write operation has been completed, a Callback Procedure may be implemented (1116) in order to update the header information of the flushed “dirty” disk page(s) to indicate that the flushed page(s) are no longer dirty. An example of a Callback Procedure is illustrated in FIG. 12 of the drawings.

It will be appreciated that the technique of the present invention provides a number of advantages which may be used for optimizing and enhancing storage and retrieval of information to and from the inventive database system. For example, unlike conventional RDBMS systems, new versions of objects may be stored at any desired location in the persistent memory, whereas conventional techniques require that updated information relating to a particular object be stored at a specific location in the persistent memory allocated to that particular object. Accordingly, the technique of the present invention allows for significantly improved disk access performance. For example, in conventional database systems, the disk head must be continuously repositioned each time information relating to a particular object is to be updated. However, using the optimized block write technique of the present invention as described above, updated object data may continuously be written in a sequential manner to the disk. This feature significantly improves disk access speed since the disk head does not need to be repositioned with each new portion of updated object data that is to be written to the disk. Thus, not only does the optimized block write technique of the present invention provide for optimized disk write performance, but the speed at which the write operations may be performed may also be significantly improved since the disk block write operations may be performed in a sequential manner.

FIG. 12 shows a flow diagram of a Callback Procedure 1200 in accordance with a specific embodiment of the present invention. According to one implementation, the Callback Procedure 1200 may be implemented or initiated by the Disk Manager. As shown at 1204 the callback procedure or function may be configured to cause the Cache Manager to update the header information in each of the flushed dirty disk pages to indicate that the flushed disk pages are no longer dirty. According to a specific embodiment, the header of a flushed disk page residing in the data server cache may be updated with the new disk address of the location in the persistent memory where the corresponding disk page was stored.

Data Recovery

Crash recovery functionality is an important component of most database systems. For example, as described previously, most conventional RDBMS systems utilize a transaction log file in order to preserve data integrity in the event of a crash. Additionally, the use of atomic transactions may also be implemented in order to further preserve data integrity in the event of a system crash. An atomic transaction or operation implies that the transaction must be performed entirely or not at all.

Typically, when rebuilding the database in a conventional RDBMS system, the saved disk data is loaded into the memory cache, whereupon the cached data is then updated using information from the transaction log file. Typically, the larger the transaction log file, the more time it takes to rebuild the database.

Unlike conventional database recovery techniques, the technique of the present invention does not use a transaction log file to provide database recovery functionality. Further, as explained in greater detail below, the amount of time it takes to fully recover the database information using the technique of the present invention may be independent of the size of the database.

According to a specific embodiment, each time a particular object in the database is updated or modified, a new version of that object is created. When the new object version is created, a copy of the new object version is stored in a disk page buffer in the data server cache. If the data in the disk page buffer is inconsistent with the data in the corresponding disk page stored in the persistent memory (if present), then the cached disk page may be flagged as being “dirty”. In order to ensure data integrity, it is preferable to flush the dirty disk pages in the data server cache to the persistent memory as described previously, for example, with respect to FIG. 9A.

Further, according to a specific embodiment, each modification of an object in the database may be associated with a particular transaction ID. For example, before a given application is able to modify objects in the database, a new transaction session may be initiated which is assigned a specific Transaction ID value. During the transaction session, any modification of objects will be assigned the Transaction ID value for that transaction session. In a specific implementation, the modification of objects may include adding new object versions (which may also include adding a “delete” object version for a particular object). Each new object version which is created during the transaction session is tagged with the Transaction ID value for that session. As explained in greater detail below, it is preferable to commit to the persistent memory all modified data associated with a given Transaction ID so that the data may be recovered in the event of a crash.

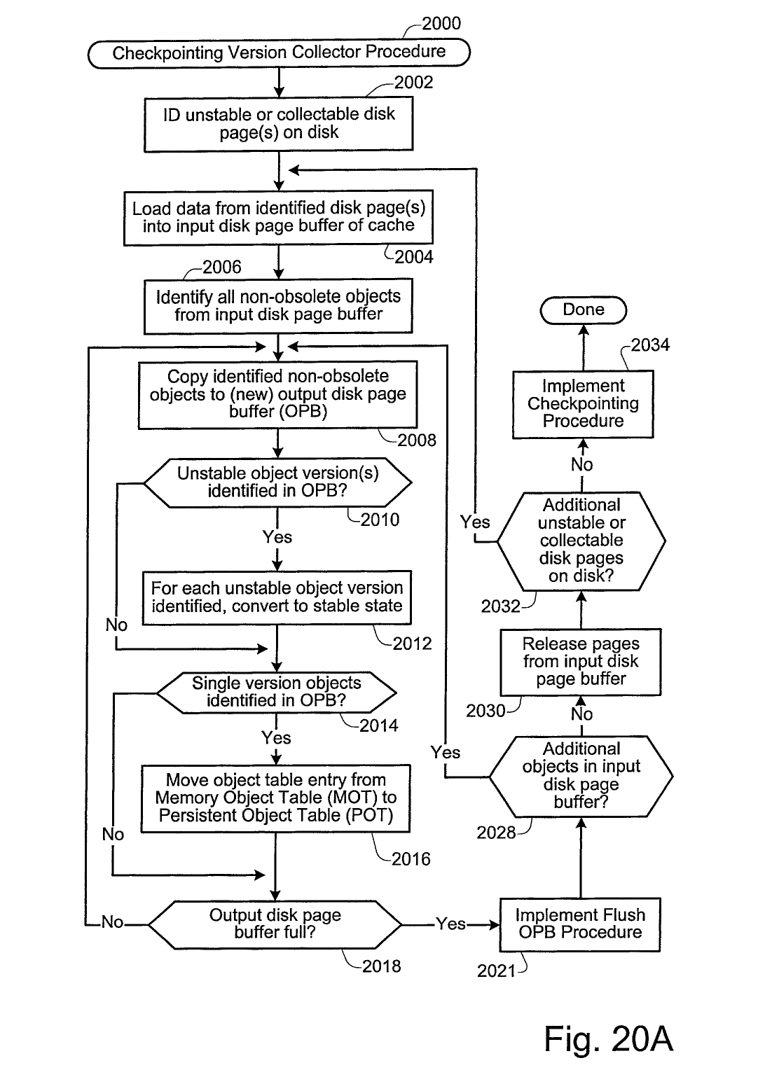

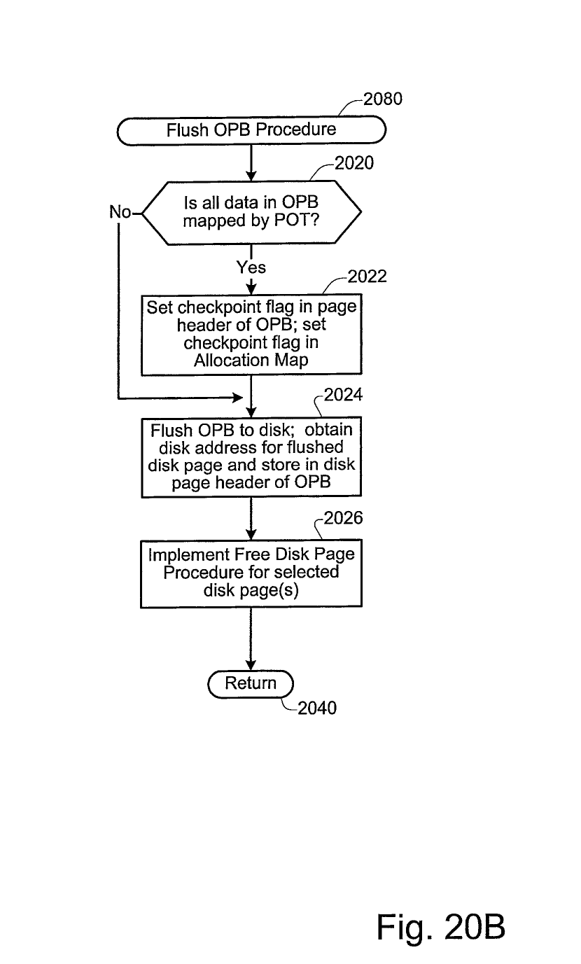

In at least one implementation, when a new object version is initially stored in the persistent memory, the header of the new object version will include a Transaction ID value corresponding to a particular transaction session. The Transaction ID for the new object version will eventually be remapped to a new Version ID for that particular object. This is explained in greater detail below with respect to FIG. 20A.

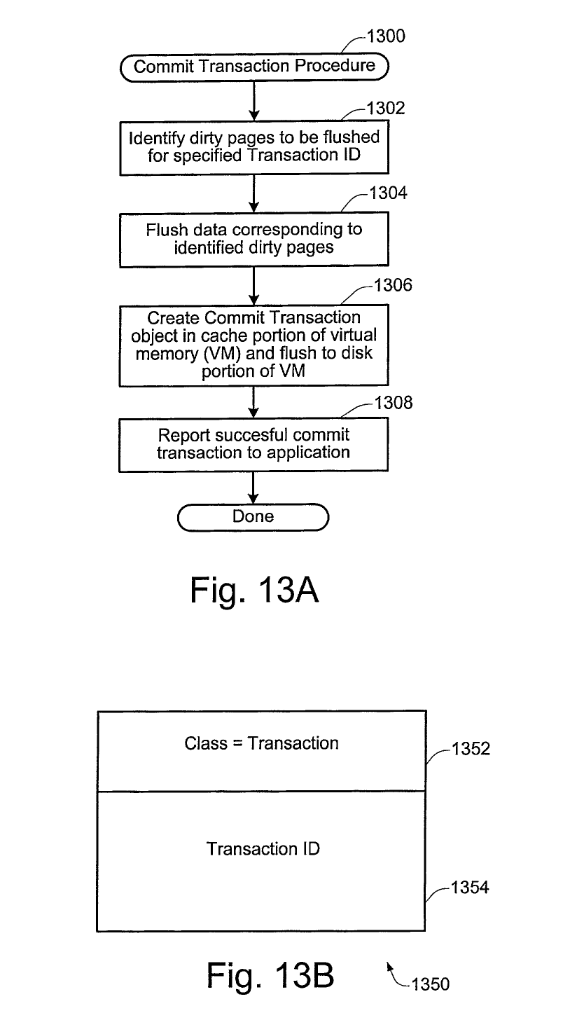

FIG. 13A shows a flow diagram of a Commit Transaction Procedure 1300 in accordance with a specific embodiment of the present invention. As explained in greater detail below, the Commit Transaction Procedure may be used to commit all transactions from the data server cache which are associated with a particular Transaction ID. According to one embodiment, the Commit Transaction Procedure may be implemented by the Transaction Manager.

Initially, as shown at 1302, the Transaction Manager identifies selected dirty disk pages in the data server cache which are associated with a specified Transaction ID. Data from the identified dirty disk pages is then flushed (1304) to the persistent memory. This may be accomplished, for example, by initiating the Cache Manager Flush Procedure 1000 (FIG. 10) for the specified Transaction ID.

After flushing all of the identified dirty disk pages in the data server cache associated with a specified Transaction ID, a Commit Transaction object is created (1306) in the data server cache portion of the virtual memory for the specified Transaction ID, and then flushed to the persistent memory portion of the virtual memory. An example of a Commit Transaction object is shown in FIG. 13B of the drawings.

FIG. 13B shows a block diagram of a Commit Transaction object 1350 in accordance with a specific embodiment of the present invention. According to one implementation, the format of the Commit Transaction object may correspond to the database object format shown in FIG. 8B of the drawings. The Commit Transaction object of FIG. 13B includes a header portion 1352, which identifies the class of the object 1350 as a transaction object. The Commit Transaction object also comprises a data portion 1354 which includes the Transaction ID value associated with that particular Commit Transaction object.

Returning to the example of FIG. 13A, once the Commit Transaction object has been flushed to the persistent memory, the Commit Transaction Procedure may report (1308) the successful commit transaction to the application. According to a specific embodiment, any desired amount of data (e.g. 1 gigabyte of data), including multiple object versions, may be committed using a single Commit Transaction object.

According to a specific embodiment, once a Commit Transaction object has been flushed to the persistent memory, all updates associated with the Transaction ID of the Commit Transaction object may be considered to be stable for the purpose of rebuilding the database. Thus, it will be appreciated that, according to one embodiment, database recovery may be performed without the use of a transaction log file. Further, since the data associated with a given committed transaction is capable of being recovered once the transaction has been committed, database recovery may be performed without performing any checkpointing of the committed transaction or related data.

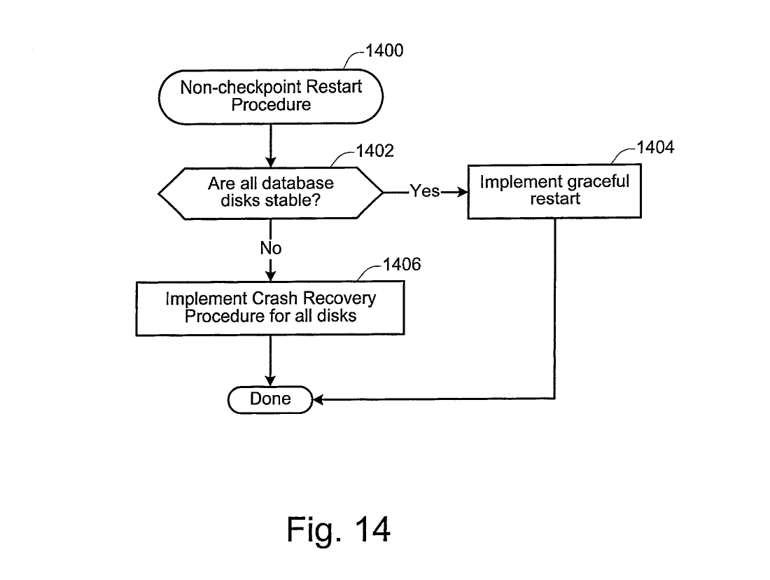

FIG. 14 shows a flow diagram of a Non-Checkpoint Restart Procedure 1400 in accordance with a specific embodiment of the present invention. The Non-Checkpoint Restart Procedure 1400 may be implemented, for example, following a system crash or failure in order to rebuild the database.

Initially, upon restart or initialization of the database server, each of the disks in the database persistent memory may be scanned in order to determine (1402) whether all of the disks are stable. According to one implementation, the header portion of each disk may be checked in order to determine whether the disk had crashed or was gracefully shut down. According to the embodiment of FIG. 14, if a disk was gracefully shut down, then the disk is considered to be stable.

If it is determined that all database disks are stable, then it may be assumed that all data in each of the disks is stable. Accordingly, a Graceful Restart Procedure may then be implemented (1404). During the Graceful Restart Procedure, the memory portion of the Object Table (i.e., Memory Object Table) may be created by loading into the program memory information from the portion of the Object Table that has been stored in the persistent memory (i.e., the Persistent Object Table). Thereafter, the database server may resume its normal operation.

If, however, it is determined that any one of the database disks is unstable (e.g. has not been shut down gracefully), then a Crash Recovery Procedure may be implemented (1406) for all the database disks.

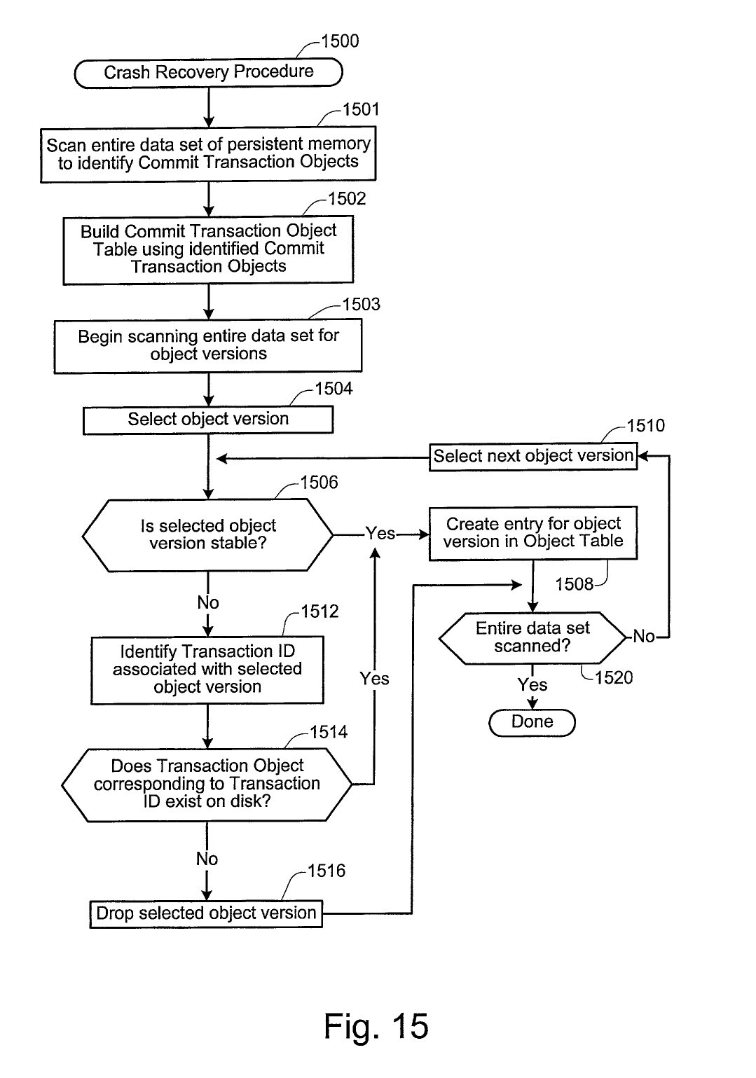

FIG. 15 shows a flow diagram of a Crash Recovery Procedure 1500 in accordance with a specific embodiment of the present invention. According to a specific embodiment, the Crash Recovery Procedure 1500 may be used to rebuild or reconstruct the Object Table using the data stored in the persistent memory. In on implementation, the Crash Recovery Procedure 1500 may be implemented, for example, by the Object Manager following a crash or failure of the database server.

Initially, as shown at 1501 of FIG. 15, the entire data set of the persistent memory may be scanned to identify Commit Transaction objects stored therein. The identified Commit Transaction objects may then be used to build (1502) a Commit Transaction Object Table which may be used, for example, to determine whether a particular Commit Transaction object corresponding to a specific Transaction ID exists within the persistent memory.

After the entire data set has been scanned for Commit Transaction objects, the Crash Recovery Procedure begins scanning (1503) the entire data set for object versions stored therein. When an object version has been identified, the object version is selected (1504) and analyzed to determine (1506) whether the selected object version is stable. According to a specific embodiment, an object version is considered to be stable if it has been assigned a Version ID. According to a specific implementation, the Version ID or Transaction ID of a selected object version may be identified by inspecting the header portion of the object version.

If it is determined that the selected object version is stable (e.g., the object version has been assigned a Version ID), then an entry for that object version is created (1508) in the Object Table. Thereafter, the scanning of the disks may continue until the next object version is identified and selected (1510).

If, however, it is determined that the selected object version is not stable (e.g., the selected object version has been assigned a Transaction ID but not a Version ID), then the selected object version is inspected to identify (1512) the Transaction ID associated with the selected object version. Once the Transaction ID has been identified, a determination is made (1514) as to whether a Commit Transaction object corresponding to the identified Transaction ID exists on any of the disks. According to a specific implementation, this determination may be made be checking the Commit Transaction Object Table to see if an entry for the corresponding Transaction ID exists in the table. If a Commit Transaction object corresponding to the identified Transaction ID is found to exist in the persistent memory, then it may be assumed that the selected object version is valid and stable. Accordingly, an entry for the selected object version may be created (1508) in the Object Table.

According to a specific implementation, the new Object table entry may first be created in the Memory Object Table of the program memory, which may then be flushed to the Persistent Object Table of the virtual memory. If, however, the Commit Transaction object corresponding to the identified Transaction ID can not be located in the persistent memory, then the selected object version may be dropped (1516). For example, if the selected object version was created during an aborted transaction, then there will be no Commit Transaction object for the Transaction ID associated with the aborted transaction. Accordingly, the selected object version may be dropped. Additionally, according to one implementation, other unstable objects or object versions associated with the identified Transaction ID may also be dropped.

After the new entry for the selected object version has been created in the Object Table, a determination may then be made (1520) as to whether the entire data set has been scanned. If the entire data set has not yet been scanned, a next object version in the database may then be identified and selected (1510) for analysis.

It will be appreciated that since the Crash Recovery Procedure of FIG. 15 involves at least one scan of the entire data set, full recovery of a relatively large database may be quite time consuming. In order to reduce the recovery time needed for rebuilding the database following a system crash, an alternate embodiment of the present invention provides a database recovery technique which utilizes a checkpointing mechanism for creating stable areas of data in the persistent memory which may immediately be recovered upon restart.

Conventional checkpointing techniques which may be used in RDBMS systems typically involve a two-step process wherein the entire data set in the memory cache is first flushed to the disk, and the transaction log is subsequently truncated. However, as explained in greater detail below, the checkpointing mechanism of the present invention is substantially different than checkpointing techniques used in conventional information storage and retrieval systems.

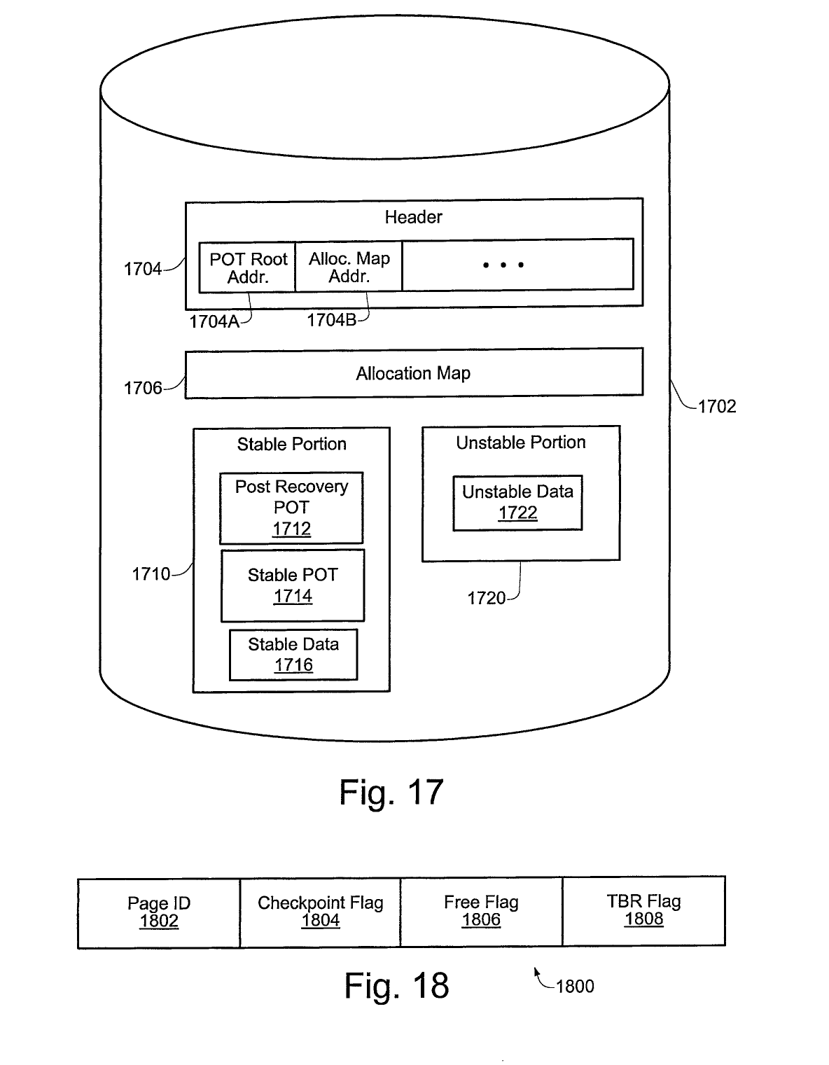

FIG. 17 shows a block diagram of different regions within a persistent memory storage device 1702 that has been configured to implement a specific embodiment of the information storage and retrieval technique of the present invention. As shown in FIG. 17, the persistent memory device 1702 includes a header portion 1704, at least one disk allocation map 1706, a stable portion or region 1710, and an unstable portion or region 1720.

According to a specific implementation, the header portion 1704 includes a POT Root Address field 1704A, which may be configured to point to the root address of the stable Persistent Object Table 1714. In a specific implementation, the stable Persistent Object Table represents the last checkpointed Persistent Object Table that was stored in the persistent memory. Additionally, according to a specific implementation, the stable data stored in the persistent memory may correspond to checkpointed data that is referenced by the stable Object Table. The header portion may also include an Allocation Map Root Address field 1704B, which may be configured to point to the root address of the Allocation Map 1706.

As shown in the embodiment of FIG. 17, the stable region 1710 of the persistent memory device includes a “post recovery” Persistent Object Table 1712, a stable Persistent Object Table 1714, and stable data 1716. The unstable region 1720 includes unstable data 1722.

According to a specific embodiment, the stable data portion 1716 of the persistent memory includes object versions which have been mapped to Version IDs and which are also mapped to a respective entry in the Persistent Object Table. The unstable data portion 1722 of the persistent memory includes object versions which have not been mapped to a Version ID. Thus, for example, if an object version has an associated Transaction ID, it may be stored in the unstable data portion of the persistent memory. Additionally, the unstable data portion 1722 may also include objects which have multiple entries in the Object Table. For example, where different versions of the same Object Are currently in use by different users, at least one of the object versions may be stored in the unstable data portion of the persistent memory.

In at least one embodiment where the persistent memory includes a plurality of disk drives, each disk drive may be configured to include at least a portion of the regions and data structures shown in the persistent memory device of FIG. 17. For example, where the persistent memory includes a plurality of disks, each disk may include a respective Allocation Map 1706. Additionally, the data server cache may include a plurality of Allocation Maps, wherein each cached Allocation Map corresponds to a respective disk in the persistent memory. Further, the Disk Manager may be configured to include a plurality of independent silo writer threads, wherein each writer thread is responsible for managing Allocation Map updates (for a respective disk) in both the persistent memory and data server cache. For purposes of illustration, however, it will be assumed that the persistent memory storage device 1702 corresponds to a single disk storage device.

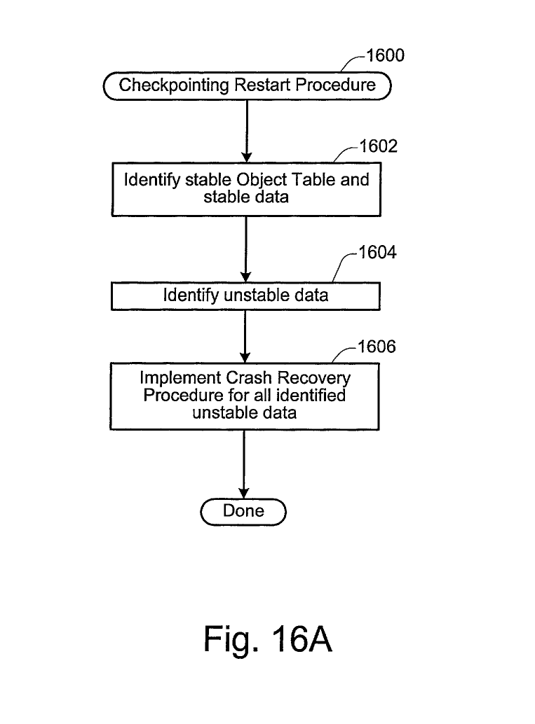

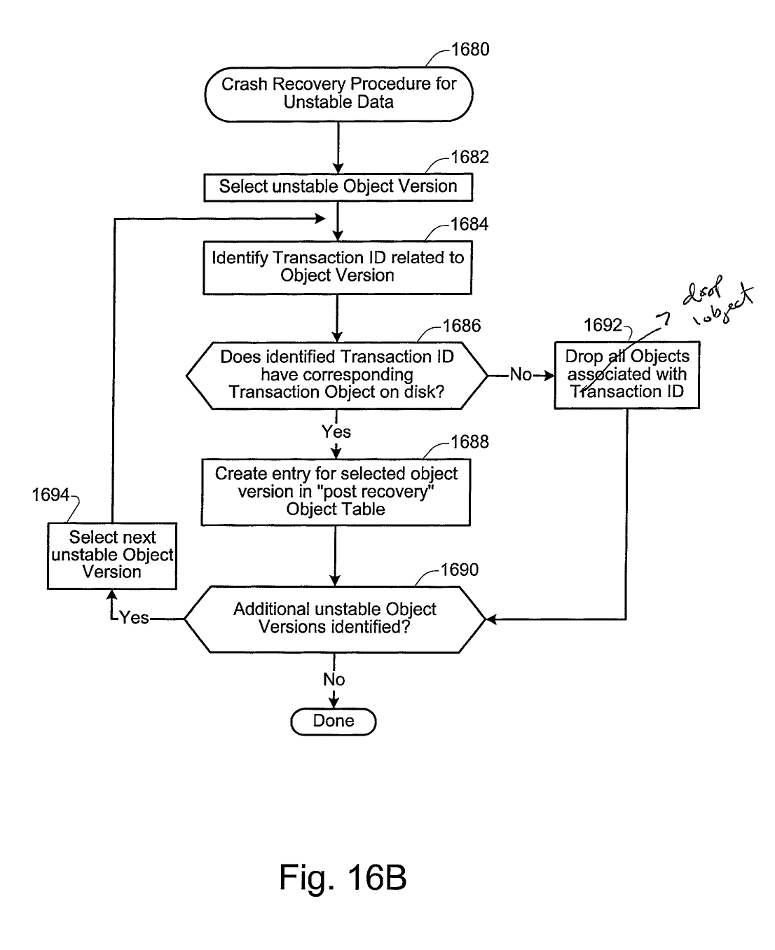

According to a specific implementation, the stable Persistent Object Table 1714 and stable data 1716 represent information which has been stored in the persistent memory using the checkpointing mechanism of the present invention. As explained in greater detail with respect to FIGS. 16A and 16B, database recovery may be achieved by retrieving the stable Persistent Object Table 1714 and using the unstable data 1722 to patch data retrieved from the stable Persistent Object Table to thereby generate a recovered, stable Object Table.

FIG. 16A shows a flow diagram of a Checkpointing Restart Procedure 1600 in accordance with a specific embodiment of the present invention. The Checkpointing Restart Procedure 1600 may be implemented, for example, by the Object Manager following a restart of the database system. For purposes of illustration, it is assumed that the Checkpointing Restart Procedure 1600 is being implemented on a database server system which includes a persistent memory storage device as illustrated in FIG. 17 of the drawings.

Initially, as shown at 1602 of FIG. 16A, the Checkpointing Restart Procedure identifies (1602) the location of the stable Persistent Object Table (1714) stored in the persistent memory. According to a specific embodiment, the location of the stable Persistent Object Table may be determined by accessing the header portion (1704) of the persistent memory device in order to locate the root address (1704A) of the stable Persistent Object Table. In the example of FIG. 16A, any objects or other data identified by the stable Persistent Object Table may be assumed to be stable.

At 1604 the Checkpointing Restart Procedure identifies unstable data in the persistent memory device. According to a specific embodiment, unstable data may be defined as data stored in the persistent memory which has not been checkpointed.

In one implementation, identification of the stable and/or unstable data may be accomplished by consulting the Allocation Map (1706) stored in the persistent memory device. For example, the unstable data in the persistent memory may be identified by referencing selected fields in the Allocation Map (1706) which is stored in the persistent memory. Upon initialization or restart, the database system of the present invention may access the header portion 1704 of the persistent memory in order to determine the root address (1704B) of the Allocation Map 1706. An example of how the Allocation Map may be used to identify the unstable data in the persistent memory is described in greater detail with respect to FIG. 18 of the drawings. Once the Checkpointing Restart Procedure has identified the unstable data in the persistent memory, a Crash Recovery Procedure may then be implemented (1606) for all identified unstable data. An example of a Crash Recovery Procedure is shown in FIG. 16B of the drawings.

One advantage of the checkpointing mechanism of the present invention is that it provides for improved crash recovery performance. For example, since the stable data in the database may be quickly and easily identified by accessing the Allocation Map 1706, the speed at which database recovery may be achieved is significantly improved. Further, at least a portion of the improved recovery performance may be attributable to the fact that the stable data does not have to be analyzed to rebuild the post recovery Object Table since this information is already stored in the stable Object Table 1714. Thus, according to a specific embodiment, only the unstable data identified in the persistent memory need be analyzed for rebuilding the remainder of the post recovery Object Table.

FIG. 16B shows a flow diagram of a Crash Recovery Procedure 1680 in accordance with a specific embodiment of the present invention. According to one implementation, the Crash Recovery Procedure 1680 may be implemented to build or patch a “post recovery” Object Table using unstable data in identified in the persistent memory. In this embodiment, the Crash Recovery Procedure of the present invention may create new Object Table entries in the Memory Object Table using unstable data identified in the persistent memory. The newly created Object Table entries may then be used to patch the Persistent Object Table residing in the virtual memory.

As shown at 1682 of FIG. 16B, a first unstable object version is selected for recovery analysis. According to a specific implementation, the unstable object version may be selected from an identified unstable disk page in the persistent memory. For example, according to a specific implementation, if a particular disk page in the persistent memory is identified as being unstable, then all object versions associated with that disk page may also be considered to be unstable.

Once an unstable object version has been selected for analysis, the Transaction ID related to that object version is identified (1684). A determination may then be made (1686) as to whether there exists in the persistent memory a Commit Transaction object corresponding to the identified Transaction ID. According to a specific implementation, this determination may be made be checking the Commit Transaction Object Table to see if an entry for the corresponding Transaction ID exists in the table.

If it is determined that a Commit Transaction object corresponding to the identified Transaction ID does not exist in the persistent memory, then the selected object version may be dropped or discarded (1692). Additionally, according to a specific implementation, all other objects associated with the identified Transaction ID may also be dropped or discarded. As explained in greater detail with respect to FIG. 20A, dropped or discarded object versions may correspond to aborted transactions, and may be collected by a Checkpointing Version Collector Procedure. Once collected, the memory space allocated to the collected object versions may then be allocated for storing other data.

Returning to block 1686 of FIG. 16B, if a Commit Transaction object corresponding to the identified Transaction ID is found to exist in the persistent memory, then an entry for the selected object version may be created (1688) in a “post recovery” Object Table. According to a specific implementation, the post recovery Object Table may reside in the program memory as the Memory Object Table portion of the Object Table, and may include copies of selected entries stored in the stable Persistent Object Table 1714. When desired, selected portions of the post recovery Memory Object Table may be written to the post recovery Persistent Object Table 1712 residing in the virtual memory. In this way, recovery of the unstable data may be used to reconcile the Memory Object Table and the Persistent Object Table.

At 1690 a determination is made as to whether there exists additional unstable object versions to be analyzed by the Crash Recovery Procedure. If additional unstable object versions are identified, then a next unstable object version is selected (1694) for analysis. This process may continue until all identified unstable object versions have been analyzed by the Crash Recovery Procedure.

FIG. 18 shows a block diagram of an Allocation Map entry 1800 in accordance with a specific embodiment of the present invention. As shown in FIG. 18, each entry in the Allocation Map may include a Page ID field 1802, a Checkpoint Flag field 1804, a Free Flag field 1806, and a TBR Flag field 1808. Each Allocation Map may have a plurality of entries having a format similar to that shown in FIG. 18.

According to a specific embodiment, each entry in the Allocation Map may correspond to a particular disk page stored in the persistent memory. In one embodiment, a Page ID field 1802 may be used to identify a particular disk page residing in the persistent memory. In an alternate embodiment, the Page ID field may be omitted and the offset position of each Allocation Map entry may be used to identify a corresponding disk page in the persistent memory. In different implementations, the Page ID field may include a physical address or a logical address, either of which may be used for locating a particular disk page in the persistent memory.

The Checkpoint Flag field 1804 may be used to identify whether or not the particular disk page has been checkpointed. According to a specific embodiment, a “set” Checkpoint Flag may indicate that the disk page identified by the Page ID field has been checkpointed, and therefore that the data contained on that disk page is stable. However, if the Checkpoint Flag has not been “set”, then it may be assumed that the corresponding disk page (identified by the Page ID field) has not been checkpointed, and therefore that the data associated with that disk page is unstable.

The Free Flag field 1806 may be used to indicate whether the memory space allocated for the identified disk page is free to be used for storing other data. The TBR (or “To Be Released”) Flag field 1808 may be used to indicate whether the memory space allocated to the identified disk page is to be freed or released after a checkpointing operation has been performed. For example, if it is determined that a particular disk page in the persistent memory is to be dropped or discarded, the TBR Flag field in the entry of the Allocation Map corresponding to that particular disk page may be “set” to indicate that the memory space occupied by that disk page may be released or freed after a checkpoint operation has been completed. After a checkpointing operation has been completed, the Free Flag in the Allocation Map entry corresponding to the dropped disk page may then be “set” to indicate that the memory space previously allocated for that disk page is now free or available to be used for storing new data. According to a specific implementation, the Checkpoint Flag field 1084, Free Flag field 1806, and TBR Flag field 1808 may each be represented by a respective binary bit in the Allocation Map.

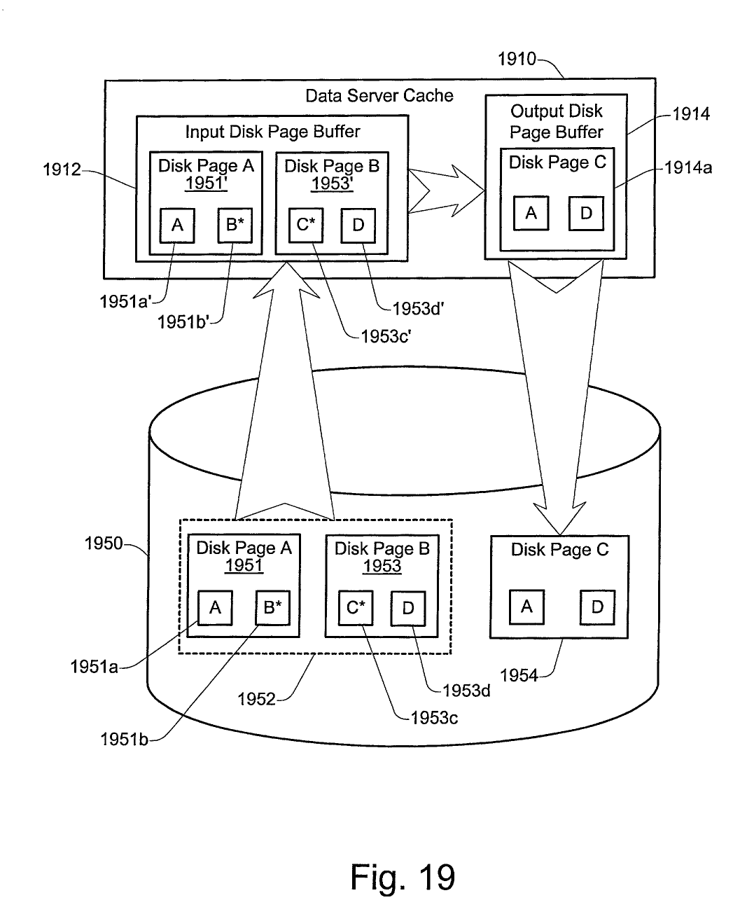

FIG. 19 shows a block diagram illustrating how a checkpointing version collector technique may be implemented in a specific embodiment of the database system of the present invention. An example of a Checkpointing Version Collector Procedure is shown in FIG. 20A of the drawings. As explained in greater detail with respect to FIG. 20A, the Checkpointing Version Collector Procedure may perform a variety of functions such as, for example, identifying stable data in the persistent memory, identifying obsolete objects in the database, and increase available storage space in the persistent memory by deleting old disk pages having obsolete objects and consolidating non-obsolete objects from old disk pages into new disk pages.

FIG. 20A shows a flow diagram of a Checkpointing Version Collector Procedure 2000 in accordance with a specific embodiment of the present invention. As explained in greater detail below, the Checkpointing Version Collector Procedure may be used to increase available storage space in the persistent memory, for example, by analyzing the data stored in the persistent memory, deleting obsolete objects, and/or consolidating non-obsolete objects into new disk pages. According to at least one implementation, the Checkpointing Version Collector Procedure may be initiated by the Version Collector Manager 703 of FIG. 7B. In one implementation, the Checkpointing Version Collector Procedure may be configured to run asynchronously from other processes or procedures described herein. For purposes of illustration, it will be assumed that the Checkpointing Version Collector Procedure 2000 is being implemented to perform version collection analysis on the data server shown in FIG. 19.

Initially, the Checkpointing Version Collector Procedure identifies (2002) unstable or collectable disk pages stored in the persistent memory. According to a specific embodiment, an unstable or collectable disk page may be defined as one which includes at least one unstable or collectable object version. According to one implementation, an object version is not considered to be “collectible” if (1) it is the most recent version of that object, or (2) it is currently being used or accessed by any user or application.

In the example of FIG. 19, disk pages 1951 and 1953 represent collectible disk pages in the persistent memory. In this example, each obsolete object may be identified as a box which includes an asterisk “*”. Thus, for example, Disk Page A 1951 includes a first non-obsolete Object Version A (1951a) and a second, obsolete Object Version B (1951b). Disk page B also includes one obsolete Object Version C (1953c) and one non-obsolete Object Version D (1953d).

As shown at 2004 of FIG. 20A, copies of the identified unstable or collectible disk pages are loaded into one or more input disk page buffers of the data server cache. Thus, for example, as shown in FIG. 19, copies of disk pages 1951 and 1953 are loaded into input disk page buffer 1912 of the data server cache 1910.

According to a specific embodiment, the input disk page buffer 1912 may be configured to store information relating to a plurality of disk pages which have been copied from the persistent memory 1950. For example, in one implementation, the input disk page buffer 1912 may be configured to store up to 32 disk pages of 8 kilobytes each. Thus, for example, after the Checkpointing Version Collector Procedure has loaded 32 disk pages from the disk into the input disk page buffer, it may then proceed to analyze each of the loaded disk pages for version collection. Alternatively, a plurality of input disk page buffers may be provided in the data server cache for storing a plurality of unstable or collectable disk pages.

The Checkpointing Version Collector Procedure then identifies (2006) all non-obsolete object versions in the input disk page buffer(s). According to one embodiment, the Object Table may be referenced for determining whether a particular object version is obsolete. According to one implementation, an object version may be considered obsolete if it is not the newest version of that object and it is also collectable. In the example of FIG. 19, it is assumed that Object B (1951b′) and Object C (1953c′) of the input disk page buffer 1912 are obsolete.

As shown at 2008, all identified non-obsolete object versions are copied from the input disk page buffer(s) to one or more output disk page buffers. In the example of FIG. 19, it is assumed that Object Versions A and D (1953a′, 1953d′) are both non-obsolete, and are therefore copied (2008) from the input disk page buffer 1912 to the output disk page buffer 1914. According to a specific embodiment, a plurality of output disk page buffers may be used for implementing the Checkpointing Version Collector Procedure of the present invention. For example, when a particular output page buffer becomes full, a new output disk page buffer may be created to store additional object versions to be copied from the input page buffer(s). In a specific embodiment, each output disk page buffer may be configured to store one 8-kilobyte disk page.

At 2010 a determination is made as to whether one or more object versions in the output disk page buffer(s) are unstable. According to a specific embodiment, an unstable object version is one which has not been assigned a Version ID. Thus, for example, if a selected object version in the output disk page buffer 1914 has an associated Transaction ID, it may be considered to be an unstable object version. If it is determined (2010) that a selected object version of the output disk page buffer(s) is unstable, then the selected object version may be converted (2012) to a stable state. According to a specific embodiment, this may be accomplished by remapping the Transaction ID associated with the selected object version to a respective Version ID.

At 2014 a determination is made as to whether any single object versions have been identified in the output disk page buffer(s). According to a specific embodiment, for each single object version identified in the output disk page buffer 1914, the object table entry corresponding to the identified single object version is moved (2016) from the Memory Object Table to the Persistent Object Table. This aspect has been described previously with respect to FIG. 6 of the drawings.

At 2018 a determination is made as to whether the output disk page buffer 1914 has become full. According to a specific implementation, the output disk page buffer 1914 may be configured to store a maximum of 8 kilobytes of data. If it is determined that the output disk page buffer is not full, additional non-obsolete object data may be copied from the input disk page buffer to the output disk page buffer and analyzed for version collection.

When it is determined that the output disk page buffer has become full, then the disk page portion of the output disk page buffer may be flushed (2021) to the persistent memory. In the example of FIG. 19, the disk page portion 1914a of the output disk page buffer 1914 is flushed to the persistent memory 1950 as by Disk Page C 1954. According to a specific embodiment, the VC Manager may implement the Flush Output Disk Page Buffer (OPB) Procedure of FIG. 20B to thereby cause the disk page portion of the output disk page buffer 1914 to be flushed to the persistent memory 1950.

According to a specific embodiment, after a particular output disk page buffer has been flushed to the persistent memory, that particular output disk page buffer may continue to reside in the data server cache (if desired). At that point, the cached disk page (e.g. 1914a) may serve as a working copy of the corresponding disk page (e.g. 1954) stored in the persistent memory.

As shown at 2028 of FIG. 20A, a determination is then made as to whether there are additional objects in the input disk page buffer to be analyzed for version collection. If it is determined that there are additional objects in the input disk page buffer to be analyzed for version collection, a desired portion of the additional object data may then be copied from the input disk page buffer to a new output disk page buffer (not shown in FIG. 19). Thereafter, the Checkpointing Version Collector Procedure may then analyze the new output disk page buffer data for version collection and checkpointing.

Upon determining that there are no additional objects in the input disk page buffer(s) to be analyzed for version collection, the disk pages that were loaded into the input disk page buffer(s) may then be released (2030) from the data server cache. Thereafter, a determination is made (2032) as to whether there are additional unstable or collectible disk pages in the persistent memory which have not yet been analyzed for version collection using the Checkpointing Version Collector Procedure. If it is determined that there are additional unstable or collectible pages in the persistent memory to be analyzed for version collection, at least a portion of the additional disk pages are loaded into the input disk page buffer of the data server cache and subsequently analyzed for version collection.

According to a specific implementation, a separate thread of the Checkpointing Version Collector Procedure may be implemented for each disk which forms part of the persistent memory of the information storage and retrieval system of the present invention. Accordingly, it will be appreciated that, in embodiments where a persistent memory includes multiple disk drives or other memory storage devices, separate threads of the Checkpointing Version Collector Procedure may be implemented simultaneously for each respective disk drive, thereby substantially reducing the amount of time it takes to perform a checkpointing operation for the entire persistent memory data set.

As shown at 2034 of FIG. 20A, after the Checkpointing Version Collector Procedure has analyzed all of the unstable and collectible disk pages of all or a selected portion of the persistent memory, a Checkpointing Procedure may then be implemented (2034). An example of a Checkpointing Procedure is illustrated and described in greater detail below with respect to FIG. 21 of the drawings.

FIG. 20B shows a flow diagram of a Flush Output Disk Page Buffer (OPB) Procedure 2080 in accordance with a specific embodiment of the present invention. One function of the Flush OPB Procedure 2080 is to flush a disk page portion of a specified output disk page buffer from the data server cache to the persistent memory. For purposes of illustration, it is assumed that the Flush OPB Procedure of FIG. 20B is being implemented using the output buffer page 1914 of FIG. 19.

As shown at 2020 in FIG. 20B, a determination is made as to whether all data in the output disk page buffer has been mapped by the Persistent Object Table. According to a specific embodiment, each object in the output disk page buffer is preferably mapped to a respective entry in the Persistent Object Table. The Version Collector Manager 703 may keep track of the mappings between the objects in the output disk page buffer and their corresponding entries in the Persistent Object Table.

If it is determined that each of the object versions in the output disk page buffer have been mapped by the Persistent Object Table, then a Checkpoint Flag (e.g. 807, FIG. 8A) in the disk page header portion of the output disk page buffer may be set (2022). Additionally, a Checkpoint Flag (e.g. 1804, FIG. 18) may also be set in the Allocation Map entry corresponding to the disk page portion of the output disk page buffer. According to a specific embodiment, the data server cache may include an Allocation Map having a similar configuration to that of the Allocation Map 1706 of FIG. 17. When a new disk page corresponding to the output page buffer is flushed to the persistent memory, a Checkpoint Flag corresponding to the new disk page may be set in the Allocation Map residing in the data server cache. Eventually, the updated Allocation Map information stored in the data server cache will be flushed to the Allocation Map 1706 in the persistent memory.

In embodiments where multiple disk pages in the output disk page buffer exist, the respective Checkpoint Flag field flag may be set in each of the disk page headers of the output disk page buffer, as well as each of the corresponding Allocation Map entries.

Returning to 2020 of FIG. 20B, if it is determined that at least one object version in the output disk page buffer has not been mapped by the Persistent Object Table, then the disk page will not be considered to be stable. Accordingly, the Checkpoint Flag will not be set in the disk page portion of the output disk page buffer; nor will the Checkpoint Flag be set in the Allocation Map entry corresponding to the disk page portion of the output disk page buffer.

At 2024 the disk page portion of the output disk page buffer is flushed to the persistent memory. In the example of FIG. 19, disk page portion 1914a of the output disk page buffer 1914 is flushed to the persistent memory 1950 to thereby create a new Disk Page C (1954) in the persistent memory which includes copies of the stable and non-obsolete objects of disk pages 1951 and 1953. Additionally, as shown at 2024, the disk address of the new disk page 1954 may be written in the header portion of the cached disk page 1914a in the data server cache.

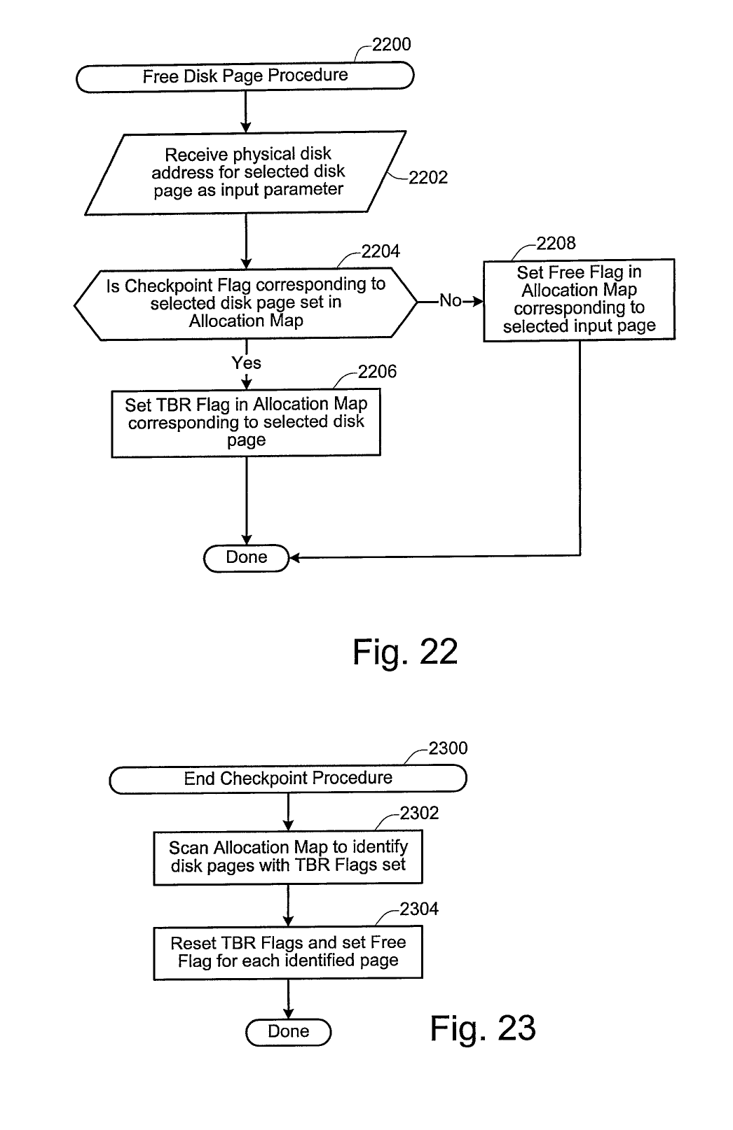

In the example of FIG. 19, the new Disk Page C (1954) has been configured to include copies of the stable and non-obsolete objects previously stored in disk pages 1951 and 1953. Accordingly, disk pages 1951 and 1953 may be discarded since they now contain either redundant object information or obsolete object information. Thus, as shown at 2026 of FIG. 20B, a Free Disk Page Procedure may be implemented for selected disk pages (e.g. Disk Pages 1951, 1953) in order to allow the disk space allocated for these disk pages to be freed or released. According to a specific implementation, Free Disk Page Procedure may be implemented by the Disk Manager. An example of a Free Disk Page Procedure is described in greater detail with respect to FIG. 22 of the drawings.

FIG. 22 shows a flow diagram of a Free Disk Page Procedure 2200 in accordance with a specific embodiment of the present invention. One function of the Free Disk Page Procedure is to analyze specified disk pages in order to determine whether a “To Be Released” (TBR) Flag associated with each specified disk page should be set in order to allow the disk space allocated for these disk pages to be freed or released. According to a specific implementation, the Free Disk Page Procedure may be evoked, for example, by the Version Collector Manager 703 and handled by the Disk Manager 710 (FIG. 7B).

As shown at 2202 of FIG. 22, the Free Disk Page Procedure may receive as an input parameter one or more disk addresses of selected disk pages that reside in the persistent memory. In the example of FIG. 22, it is assumed that the physical disk address corresponding to a selected disk page is passed as an input parameter to the Free Disk Page Procedure.

At 2204 a determination is made as to whether a Checkpoint Flag has been set in the selected disk page. According to one embodiment, the header of the disk page stored in the persistent memory may be accessed to determine whether the associated Checkpoint Flag has been set. According to an alternate embodiment, the Allocation Map entry in the data server cache corresponding to the selected disk page may be accessed to determine whether the associated Checkpoint Flag for that disk page has been set. It will be appreciated that the decision to be made at block 2204 may be accomplished more quickly using this latter embodiment since a disk access operation need not be performed.

If it is determined that the Checkpoint Flag for the selected disk page has not been set, then the Free Flag is set in the data server cache Allocation Map entry corresponding to the selected disk page. According to a specific embodiment, the setting of a Free Flag in an Allocation Map entry (corresponding to particular disk page) may be interpreted by the Disk Manager to mean that the disk space that has been allocated for the particular disk page in the persistent memory is now free to be used for storing other information.

If, however, it is determined that the Checkpoint Flag corresponding to the selected disk page has been set, then the TBR Flag may be set in the data server cache Allocation Map entry corresponding to the selected disk page. According to a specific embodiment, the setting of the TBR flag in an Allocation Map entry (corresponding to a particular disk page) indicates that the memory space allocated for that particular disk page in the persistent memory is to be freed or released after a checkpointing operation has been completed. Additionally, according to a specific implementation, if desired, the TBR flag (e.g. 809, FIG. 8A) may also be set in the header portion of the selected disk page in the persistent memory.

According to one embodiment, once a TBR flag has been set for a specified disk page in the persistent memory, the memory space allocated for that disk page will be freed or released upon successful completion of a checkpoiniting operation. In specific implementations of the present invention which include checkpointing mechanisms, disk pages may be released from the persistent memory only after successful completion of a current checkpointing operation. Thus, for example, as described in greater detail below with respect to FIG. 21, once the Checkpointing Procedure 2100 has been completed, an End Checkpoint Procedure may then be implemented to free disk pages in the persistent memory that have been identified as having set TBR flags.

FIG. 21 shows a flow diagram of a Checkpointing Procedure 2100 in accordance with a specific embodiment of the present invention. According to one implementation, the Checkpointing Procedure 2100 may be implemented after the Free Disk Page procedure has been implemented for one or more disk pages in the persistent memory. Alternatively, as described previously with respect to FIG. 6, the Checkpointing Procedure may be configured to be initiated in response to detecting that a threshold amount of new stable data has been generated, or in response to detecting that a threshold amount of unstable data has either been marked for deletion or has been converted to stable data. It will be appreciated that one function of the Checkpointing Procedure 2100 is to free persistent memory space such as, for example, disk space allocated for disk pages with set TBR flags. Another function of the Checkpointing Procedure 2100 is to stablize data within the database system in order to help facilitate and/or expedite any necessary crash recovery operations.

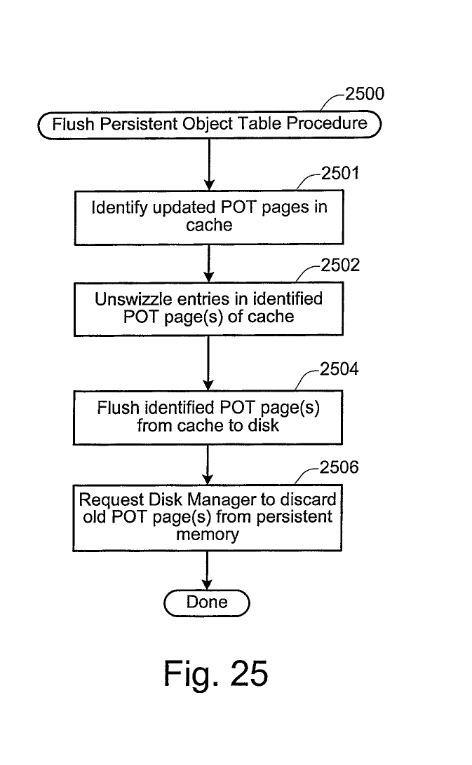

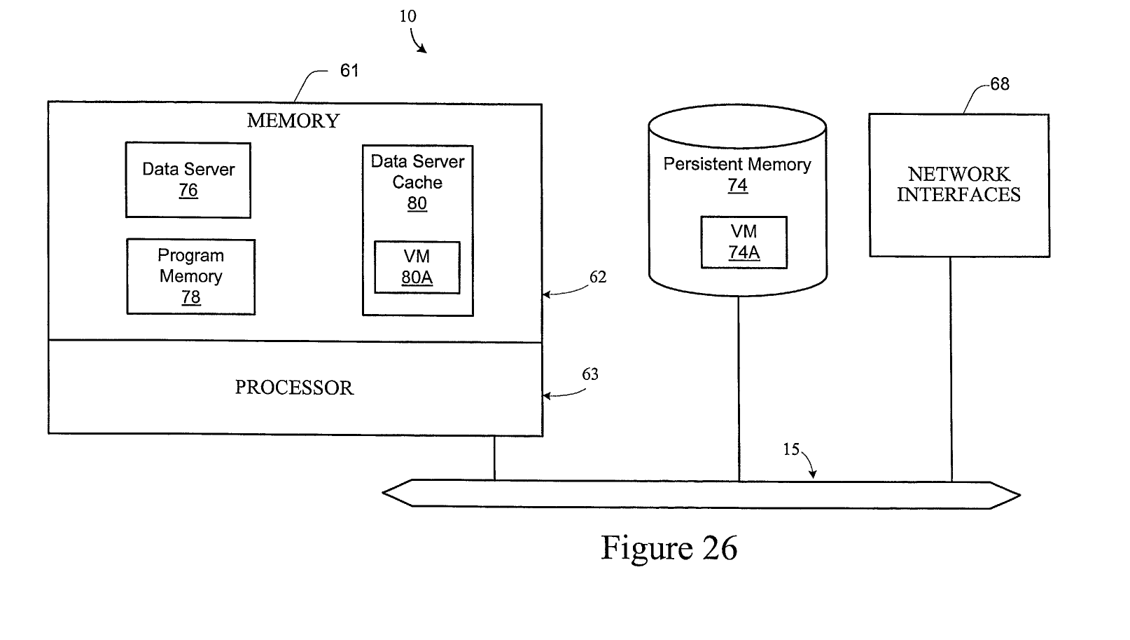

In the example of FIG. 21, it is assumed that the Checkpointing Procedure 2100 has been implemented following block 2032 of FIG. 20A. Initially, as shown at 2101 of FIG. 21, a Flush Persistent Object Table (POT) Procedure may be implemented in order to cause updated POT information stored in the data server cache to be flushed to the POT of the persistent memory. An example of a Flush POT Procedure is described in greater detail with respect to FIG. 25 of the drawings.

At 2102, the Checkpoint Flag data stored in the Allocation Map of the persistent memory (e.g. 1706, FIG. 17) is migrated to the Allocation Map residing in the data server cache. According to a specific embodiment, the data server cache includes a current or working Allocation Map which comprises updated information relating to checkpointing and version collection procedures. Additionally, the persistent memory comprises a saved Allocation Map (e.g. 1706, FIG. 17), which includes checkpointing and version collection information relating to the last successfully executed checkpointing operation. During the Checkpointing Procedure 2100, the Checkpoint Flag information stored in the saved Allocation Map of the persistent memory is migrated (2102) to the current Allocation Map residing in the data server cache. Thereafter, the current Allocation Map is flushed (2104) to the persistent memory. Presumably, at this point, the data in the data server cache Allocation Map should preferably be synchronous with the data in the persistent memory Allocation Map.

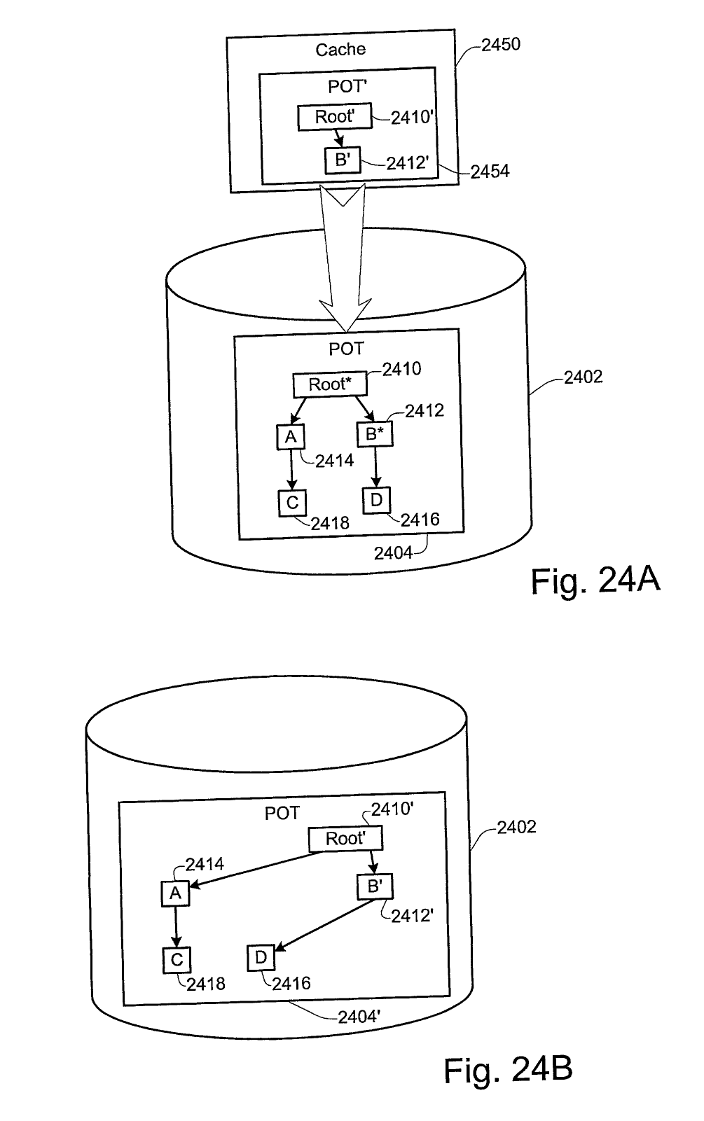

At 2106, the disk header portion of the persistent memory is updated to point to the root address of the new Persistent Object Table and the newly saved Allocation Map in the persistent memory. According to a specific embodiment, the Persistent Object Table and Allocation Map may each be represented in the persistent memory as a plurality of separate disk pages. In a manner similar to the way new object versions are stored in new disk pages in the persistent memory, when new or updated portions of the Allocation Map or Persistent Object Table are written to the persistent memory, the updated information may be stored using one or more new disk pages, which may be configured as Allocation Map disk pages or Object Table disk pages. This aspect of the present invention is described in greater detail, for example, in FIGS. 24A and 24B of the drawings. According to an alternate implementation, however, it is preferable that each Allocation Map reside completely on its respective disk.

Referring to the example of FIG. 17, the Object Table Root Address field 1704A may be updated to point to the root address of the updated Persistent Object Table, which was stored in the persistent memory during the Flush POT Procedure. Additionally, the Allocation Map Address field 1704B may be updated to point to the beginning or root address of the most recently saved Allocation Map in the persistent memory. According to a specific embodiment, the checkpointing operation may be considered to be complete at this point.

As shown at 2108, an End Checkpoint Procedure may then be implemented in order to free disk pages in the persistent memory that have been identified with set TBR flags. An example of an End Checkpoint Procedure is described in greater detail with respect to FIG. 23 of the drawings.

FIG. 23 shows a flow diagram of an End Checkpoint Procedure 2300 in accordance with a specific embodiment of the present invention. According to one implementation, the End Checkpoint Procedure may be implemented by the Disk Manager to free memory space in the persistent memory which has been allocated to disk pages that have set TBR flags.

As shown at 2302, the Allocation Map residing in the data server cache may be accessed in order to identify disk pages which have set TBR flags. In alternate implementations, the disk pages that are to be released may be identified by referencing the Allocation Map 1706 of the persistent memory, or alternatively, by checking the TBR Flag field in header portions of selected disk pages in either the data server cache and/or the persistent memory.

When a particular Allocation Map entry is identified as having a set TBR flag, the TBR flag for that entry may be reset (2304), and the Free Flag of the identified Allocation Map entry may then be set. According to a specific implementation, when the Free Flag field (e.g. 1806, FIG. 18) has been set in a particular disk page entry of the Allocation Map, the Disk Manager may consider the persistent memory space allocated for that particular disk page to be free to be used for storing other desired information.

FIGS. 24A and 24B illustrate block diagrams showing how selected pages of the Persistent Object Table may be updated in accordance with a specific embodiment of the present invention. As shown in the embodiment of FIG. 24A, portions of the Persistent Object Table (POT) 2404 may be stored as disk pages in the persistent memory 2402 and the data server cache 2450. According to a specific implementation, when updates are made to portions of the Persistent Object Table, the updated portions are first created as pages in the data server cache and then flushed to the persistent memory. In the example of FIG. 24A, it is assumed that the root node 2410 and Node B 2412 of the Persistent Object Table 2404 are to be updated.

In at least one implementation, the Persistent Object Table 2404 (residing in the persistent memory) is considered to be stable as of the last successfully completed checkpoint operation. As shown in the example of FIG. 24A, the updated POT information relating to the root node 2410′ and Node B 2412′ are stored as a POT page 2454 in the data server cache 2450. During a checkpointing operation (such as that described, for example, in FIG. 21 of the drawings) the updated POT pages stored in the data server cache may be flushed to the persistent memory in order to update and/or checkpoint the Persistent Object Table 2404 residing in the persistent memory.

FIG. 25 shows a flow diagram of a Flush Persistent Object Table Procedure 2500 in accordance with a specific embodiment of the present invention. According to a specific implementation, the Flush POT Procedure 2500 may be implemented by the Checkpoint Manager 712, and may be initiated, for example, during a Checkpointing Procedure such as that shown, for example, in FIG. 21 of the drawings. For purposes of illustration, it will be assumed that the Flush POT Procedure 2500 is being implemented on the database system shown in FIG. 24A of the drawings.

Initially, as shown at 2501 of FIG. 25, all or a selected portion of the updated POT pages in the data server cache are identified. Each of the identified POT pages in the data server cache may then be unswizzled (2502), if necessary. During this unswizzling operation, object version entries (e.g. 202B, FIG. 2) in the Object Table which point to object versions (e.g. 218) in the memory cache are unswizzled so that these entries now refer to the disk address of the corresponding object version in the persistent memory.

The identified POT pages are then flushed (2504) from the data server cache to the persistent memory. In the example of FIG. 24A, updated POT page 2454 is flushed from the cache 2450 to the persistent memory 2402. During this flush procedure, POT Page A (2414) and Page C (2418) are migrated to the new Persistent Object Table 2404′ of the persistent memory, as shown, for example, in FIG. 24B of the drawings. Thereafter, the Disk Manager may be requested to discard (2506) the old POT pages from the persistent memory. In the example of FIG. 24A, the Disk Manager may discard the old Root Page 2410 and the old Page B 2412.

Thus, it will be appreciated that, according to a specific embodiment, incremental updates to the Persistent Object Table may be achieved by implementing an incremental checkpointing technique wherein only the updated portions of the Persistent Object Table are written to the persistent memory. Moreover, the non-updated portions of the Persistent Object Table will automatically be inherited by the newly updated portions of the Persistent Object Table in the persistent memory, and therefore do not need to be re-written.

Block Write Optimization

According to at least one embodiment of the present invention, enhancements and optimizations to the block write technique (described previously with respect to FIGS. 9A and 11 of the drawings) may be implemented to improve overall performance of the information storage and retrieval system of the present invention.

For example, according to one embodiment of the present invention, disk Allocation Maps are not stored on their respective disks (or other persistent memory devices), but rather are stored in volatile memory such as, for example, the data server cache. According to this embodiment, when a particular disk page of the persistent memory is to be freed, the Free Flag may be set in the Allocation Map entry corresponding to that disk page, and a blank page written to the physical location of the persistent memory which had been allocated for that particular disk page. According to one implementation, the blank page data may be written to the persistent memory in order to assure proper data recovery in the event of a system crash. For example, if a systems crash were to occur, the Allocation Map stored in the data server cache would be lost. Therefore, recovery of the database would need to be achieved by scanning the persistent memory for data in order to rebuild the Allocation Map. The blank pages written to the persistent memory ensure that obsolete or stale data is not erroneously recovered as valid data.

It will be appreciated, however, that each time blank page data is written to a portion of a disk, the disk head must be physically repositioned to a new location. Since a substantial portion of the performance cost of a disk write operation is attributable to the positioning of the disk head, frequent repositioning of the disk head results in decreased performance of disk read and write operations. As a result, optimal performance of the block write technique of the present invention may be compromised.

To address this problem, a different embodiment of the present invention provides for improved or optimized block write capability. In this latter embodiment, a checkpointed Allocation Map is saved in the persistent memory so that a valid and stable version of the Allocation Map may be recovered in case of a system crash. Since a valid Allocation Map is able to be recovered after a system crash (or other event requiring a system restart), there is no longer a need to write blank pages to the freed disk pages of the persistent memory (as described above). Thus, according to this latter embodiment, when a disk page stored in the persistent memory is to be freed, the database system of the present invention need only set the Free Flag in the Allocation Map entry corresponding to that disk page. Moreover, since the checkpointed Allocation Map is able to be recovered after a system crash or restart, the database system of the present invention is able to use the recovered Allocation Map to determine the used and free proportions of the persistent memory without having to perform a scan of the entire persistent memory database.

Experimental data resulting from research conducted by the present inventive entity suggests the saved Allocation Map embodiment of the present invention (i.e. the embodiment which includes block writes and a saved Allocation Map in the persistent memory) provides for substantially improved disk writing performance compared to the non-saved Allocation Map embodiment (i.e. block write feature without use of saved Allocation Map in the persistent memory).

Moreover, it will be appreciated that the intrinsic versioning feature of the present invention allows for a complete system recovery even in the event the saved Allocation Map becomes corrupted. For example, if the system crashes, and the saved Allocation Map becomes corrupted, it is possible to implement recovery by scanning the entire persistent memory database for data and rebuilding the Allocation Map. Blank pages which have been written into free spaces in the persistent memory permit faster recovery. However, even in embodiments where blank pages are not written to free spaces in the persistent memory, the intrinsic versioning feature of the present invention allows the version of each object stored in the persistent memory to be identified. For example, according to one implementation, the version of each identified object may be determined by consulting the Version ID field (885, FIG. 8B) of the header portion of the object. Older versions of identical objects which are identified may then be discarded as being obsolete. Moreover, it will be appreciated that this additional recovery feature does not exist for conventional RDB systems. For example, even if a conventional RDB system were configured to store the valid copy of an Allocation Map in persistent memory, if a crash occurred in which the saved Allocation Map became corrupted, it would not be possible to reconstruct a valid data base by scanning data stored in the persistent memory, unlike the present invention.

Thus it will be appreciated that the intrinsic versioning and Allocation Map mechanisms of the present invention provide for a number of advantages which are not realized by conventional RDBMS or other ODBMS systems.

Other Embodiments

Generally, the information storage and retrieval techniques of the present invention may be implemented on software and/or hardware. For example, they can be implemented in an operating system kernel, in a separate user process, in a library package bound into network applications, on a specially constructed machine, or on a network interface card. In a specific embodiment of this invention, the technique of the present invention is implemented in software such as an operating system or in an application running on an operating system.

A software or software/hardware hybrid implementation of the information storage and retrieval technique of this invention may be implemented on a general-purpose programmable machine selectively activated or reconfigured by a computer program stored in memory. Such programmable machine may be a network device designed to handle network traffic. The network device may be configured to include multiple network interfaces including frame relay, ATM, TCP, ISDN, etc. Specific examples of such network devices include routers, switches, servers, etc. A general architecture for some of these machines will appear from the description given below. In an alternative embodiment, the information storage and retrieval technique of this invention may be implemented on a general-purpose network host machine such as a personal computer or workstation. Further, the invention may be at least partially implemented on a card (e.g., an interface card) for a network device or a general-purpose computing device.

Referring now to FIG. 26, a network device 10 suitable for implementing the information storage and retrieval technique of the present invention includes at least one central processing unit (CPU) 61, at least one interface 68, memory 62, and at least one bus 15 (e.g., a PCI bus). When acting under the control of appropriate software or firmware, the CPU 61 may be responsible for implementing specific functions associated with the functions of a desired network device. When configured as a database server, the CPU 61 may be responsible for such tasks as, for example, managing internal data structures and data, managing atomic transaction updates, managing memory cache operations, performing checkpointing and version collection functions, maintaining database integrity, responding to database queries, etc. The CPU 61 preferably accomplishes all these functions under the control of software, including an operating system (e.g. Windows NT, SUN SOLARIS, LINUX, HPUX, IBM RS 6000, etc.), and any appropriate applications software.

CPU 61 may include one or more processors 63 such as a processor from the Motorola family of microprocessors or the MIPS family of microprocessors. In an alternative embodiment, processor 63 may be specially designed hardware for controlling the operations of network device 10. In a specific embodiment, memory 62 (such as non-volatile RAM and/or ROM) also forms part of CPU 61. However, there are many different ways in which memory could be coupled to the system. Memory block 62 may be used for a variety of purposes such as, for example, caching and/or storing data, programming instructions, etc. For example, the memory 62 may include program instructions for implementing functions of a data server 76. According to a specific embodiment, memory 62 may also include program memory 78 and a data server cache 80. The data server cache 80 may include a virtual memory (VM) component 80A, which, together with the virtual memory component 74A of the non-volatile memory 74, may be used to provide virtual memory functionality to the information storage and retrieval system of the present invention.

According to at least one embodiment, the network device 10 may also include persistent or non-volatile memory 74. Examples of non-volatile memory include hard disks, floppy disks, magnetic tape, optical media such as CD-ROM disks, magneto-optical media such as floptical disks, etc.

The interfaces 68 are typically provided as interface cards (sometimes referred to as “line cards”). Generally, they control the sending and receiving of data packets over the network and sometimes support other peripherals used with the network device 10. Among the interfaces that may be provided are Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management. By providing separate processors for the communications intensive tasks, these interfaces allow the master microprocessor 61 to efficiently perform routing computations, network diagnostics, security functions, etc.

Although the system shown in FIG. 26 illustrates one specific network device of the present invention, it is by no means the only network device architecture on which the present invention can be implemented. For example, an architecture having a single processor that handles communications as well as routing computations, etc. may be used. Further, other types of interfaces and media could also be used with the network device.

Regardless of network device's configuration, it may employ one or more memories or memory modules (such as, for example, memory block 62) configured to store data, program instructions for the general-purpose network operations and/or other information relating to the functionality of the information storage and retrieval techniques described herein. The program instructions may control the operation of an operating system and/or one or more applications, for example. The memory or memories may also be configured to include data structures which store object tables, disk pages, disk page buffers, data object, allocation maps, etc.

Because such information and program instructions may be employed to implement the systems/methods described herein, the present invention relates to machine readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). The invention may also be embodied in a carrier wave travelling over an appropriate medium such as airwaves, optical lines, electric lines, etc. Examples of program instructions include both machine code, such as produced by a compiler, and files containing higher level code that may be executed by the computer using an interpreter.

Although several preferred embodiments of this invention have been described in detail herein with reference to the accompanying drawings, it is to be understood that the invention is not limited to these precise embodiments, and that various changes and modifications may be effected therein by one skilled in the art without departing from the scope of spirit of the invention as defined in the appended claims.

It is claimed:

1. A method of performing a write transaction of a data object to a database comprising:
creating an entry for a first data object in an object table, the entry containing version data for the first data object;
writing the entry for the first data object to a first memory at a first memory address;
committing the write operation by saving the first data object to a second memory at a second memory address;
identifying at least one inconsistent data page in the first memory relating to the write transaction; and
writing the identified data page to the second memory.

2. A method as recited in claim 1 further comprising associating the second memory address with the entry for the first data object stored in the object table in the first memory.

3. A method as recited in claim 1 wherein writing the entry for the first data object to a first memory further includes:
determining the first memory address of the location of the first data object in the first memory; and
storing the first memory address in the entry in the object table.

4. A method as recited in claim 3 further including replacing the first memory address in the entry with the second memory address when the entry is released from the first memory.

5. A method as recited in claim 1 wherein writing the entry for the first data object to a first memory further includes associating a null second memory address with the first data object before committing the write transaction.

6. A method as recited in claim 1 further comprising concurrently creating the entry in the object table and writing the first data object to the first memory.

7. A method as recited in claim 1 further comprising writing a newer version of the first data object to the database in real time by modifying the entry in the object table, the newer version having a newer version number.

8. A method as recited in claim 7 further comprising:
adding the newer version number to the version data contained in the entry;
writing the newer version of the first data object to the first memory; and
committing the write operation of the newer version of the first data object by saving the newer version of the first data object into the second memory at a third memory address.

9. A method as recited in claim 8 further comprising maintaining the first data object in the first memory.

10. A method as recited in claim 8 wherein the third memory address is different from the second memory address.

11. A method as recited in claim 1 further comprising writing the first data object to the first memory before saving the first data object to the second memory.

12. A method as recited in claim 1 wherein the first memory is a cache memory and the second memory is a persistent memory.

13. A method as recited in claim 12 further comprising storing the object table in a cache memory and a virtual memory.

14. A method as recited in claim 1 further comprising storing the object table in the first memory and in the second memory.

15. A method as recited in claim 1 further comprising:
determining whether the entry represents one of a single version of the first data object and multiple versions of the first data object; and
if the entry represents a single version of the data object, storing the entry in a second memory object table and clearing the entry from the object table in the first memory.

16. A method as recited in claim 15 further comprising triggering a version collection procedure if the entry represents multiple versions of the first data object.

17. A method as recited in claim 16 wherein triggering the version collection procedure further includes:
selecting an oldest version data object;
determining whether the oldest version data object is non-collectable; and
if the oldest version data object is non-collectable, deleting the oldest version data object.

18. A method as recited in claim 17 further comprising selecting a particular entry.

19. A method as recited in claim 17 wherein determining whether the oldest version data object is non-collectable further comprises determining if a specific version of a data object is being accessed or is a most recent version data object.

20. A method as recited in claim 17 further including:
determining whether the oldest version data object is marked as a deleted data object version; and
if marked as a deleted data object version, deleting the particular entry from the object table.

21. A method as recited in claim 15 wherein the second memory object table is in virtual memory.

22. A method as recited in claim 1 further comprising translating the first memory address to the second memory address using only the entry and the first memory address associated with the first data object in the first memory.

23. A method of writing data pages in an information storage and retrieval system comprising:
receiving a commit transaction command from an application;
selecting one or more data pages to be written to a first memory type from a second memory type;
writing an address of the selected data page to a system write queue buffer;
retrieving a selected data page based on the addresses in the system write queue and storing in a disk write buffer of a writer thread;
determining whether to write the selected data page to the first memory type; and
changing the address of the selected data page.

24. A computer program product of performing a write transaction of a data object to a database comprising:
a computer usable medium having computer readable code embodied therein, the computer readable code comprising:
computer code for creating an entry for a first data object in an object table, the entry containing version data for the first data object;
computer code for writing the entry for the first data object to a first memory at a first memory address;
computer code for committing the write operation by saving the first data object to a second memory at a second memory address;
computer code for identifying at least one inconsistent data page in the first memory relating to the write transaction; and
computer code for writing the identified data page to the second memory.

25. A computer program product of writing data pages in an information storage and retrieval system comprising:
a computer usable medium having computer readable code embodied therein, the computer readable code comprising:
computer code for receiving a commit transaction command from an application;
computer code for selecting one or more data pages to be written to a first memory type from a second memory type;
computer code for writing an address of the selected data page to a system write queue buffer;
computer code for retrieving a selected data page based on the addresses in the system write queue and storing in a disk write buffer of a writer thread;
computer code for determining whether to write the selected data page to the first memory type; and
computer code for changing the address of the selected data page.

26. A system for performing a write transaction of a data object to a database comprising:
means for creating an entry for a first data object in an object table, the entry containing version data for the first data object;
means for writing the entry for the first data object to a first memory at a first memory address;
means for committing the write operation by saving the first data object to a second memory at a second memory address;
means for identifying at least one inconsistent data page in the first memory relating to the write transaction; and
means for writing the identified data page to the second memory.
